(19) United States
(12) Patent Application Publication
(10) Pub. No.: US 2026/0349842 A1
(43) Pub. Date: Nov. 5, 2026

(54) SPECULATIVE MESSAGING FOR MEMORY TRANSACTIONS IN A PROCESSOR

(71) Applicant: GOOGLE LLC, Mountain View, CA (US)

(72) Inventors: Sadayan Ghows Ghani Sadayan Ebramsah Mo Abdul, Austin, TX (US); Hok Kiu Nicholas Tsang, Austin, TX (US); Tushar Ringe, Bee Cave, TX (US); Leigang Kou, Austin, TX (US); Krishnakumar Ganapathy, Bee Cave, TX (US)

(21) Appl. No.: 19/197,287

(22) Filed: May 2, 2025

(51) Int. Cl. G06F 9/52; G06F 12/0815

(52) U.S. Cl. CPC G06F 9/528; G06F 12/0815; G06F 2212/1016

(57) ABSTRACT

Implementations described herein relate to speculative messaging for memory transactions in a processor. A core of a processor may dispatch, to a cache of the processor, a speculative message configured to direct the cache to begin performing a memory transaction, the speculative message being at least partially unvalidated. The core may then determine, during a validation of the speculative message after the dispatching of the speculative message, a modification to the speculative message. In response to the determining of the modification, the core may dispatch to the cache and an override message indicating the modification. Corresponding methods, processors, and other implementations are also disclosed.

### BACKGROUND

Processors such as central processing units (CPUs) operate by performing instructions found in machine code that the processors are tasked with executing. These instructions direct one or more cores of the processor to manipulate data retrieved from memory or devices with which the processor is communicatively coupled, and, after manipulating and processing the data, to provide data to memory or the devices for storage or other use. Load/Store Units (LSUs) are a type of execution unit that a core of a processor may use to manage data transfers between registers within the core and the memory system (e.g., one or more levels of memory cache within the processor, as well as memory and devices external to the processor that the core communicates with by way of the cache). For example, LSUs may be configured to perform load instructions (reading from memory or a device, usually by way of one or more caches) and store instructions (writing to memory or a device, usually by way of one or more caches).

### SUMMARY

A core of a processor may execute memory transactions such as load and/or store transactions by communicating messages to a cache (e.g., a level-2 or L2 cache in one example). Such messages may direct the cache to perform the appropriate steps to access main memory or a memory-mapped input/output device and carry out the desired transaction. For example, if a Load/Store unit (LSU) within a processor core is tasked with loading data from a particular address in main memory, the LSU may generate and send a message that directs the cache to access the address within memory, obtain the data, and provide the requested data back to the core. Messages for memory transactions of this type generally take several clock cycles to generate (e.g., to determine and validate various parameters that are included in the message) and several more clock cycles to transmit to the cache (e.g., typically over a multi-node network that provides communication services between various cores, the cache, and other components of the processor). As described herein, this message generation time may be reduced by sending messages that are at least partially unvalidated, or, in other words, that include certain speculative parameters (rather than only those parameters that have been fully validated). When fully validated (after being dispatched) such speculative messages may generally turn out to be correct and therefore give the cache a head start (e.g., of one or a few clock cycles) as it performs the transaction. Additionally, for relatively infrequent occasions when full validation of the parameters reveals that the speculative parameters dispatched were incorrect (e.g., included some inaccuracy), methods and systems described herein also relate to techniques for overriding incorrect speculative parameters so that every message is ultimately carried out reliably. In this way, performance is improved (e.g., clock cycles are reduced) for the frequent scenario where speculative parameters turn out to be correct, while little or no performance penalty is suffered for the infrequent scenario where speculative parameters turn out to be inaccurate and are later overridden.

In some aspects, the techniques described herein relate to a method including: dispatching, from a core of a processor to a cache of the processor, a speculative message configured to direct the cache to begin performing a memory transaction, the speculative message being at least partially unvalidated; determining, by the core during a validation of the speculative message after the dispatching of the speculative message, a modification to the speculative message; and dispatching, from the core to the cache and in response to the determining of the modification, an override message indicating the modification.

In some aspects, the techniques described herein relate to a core of a processor, the core being configured to perform a process including: dispatching, to a cache of the processor, a speculative message configured to direct the cache to begin performing a memory transaction, the speculative message being at least partially unvalidated; determining, during a validation of the speculative message after the dispatching of the speculative message, a modification to the speculative message; and dispatching, to the cache and in response to the determining of the modification, an override message indicating the modification.

In some aspects, the techniques described herein relate to a processor including: a cache configured to perform memory transactions; and a core configured to direct the memory transactions by performing a process including: dispatching, to the cache, a speculative message configured to direct the cache to begin performing a memory transaction, the speculative message being at least partially unvalidated; determining, during a validation of the speculative message after the dispatching of the speculative message, a modification to the speculative message; and dispatching, to the cache and in response to the determining of the modification, an override message indicating the modification.

In some aspects, the techniques described herein relate to a method including: receiving, at a first node of a network connecting a core and a cache of a processor, a speculative message from a second node of the network; receiving, at the first node and within a fixed number of clock cycles (referred to herein as N) after receiving the speculative message, an override message from the second node, the override message including a message identifier indicating a correspondence of the override message with the speculative message; dispatching, during a first clock cycle, the speculative message from the first node to a third node of the network; and dispatching, based on the message identifier indicating the correspondence and during a second clock cycle that follows the first clock cycle by the fixed number (N) of clock cycles, the override message from the first node to the third node.

In some aspects, the techniques described herein relate to a processor including: a core configured to process instructions; a cache configured to cache data for the core; and a network connecting the core and the cache, the network including a plurality of nodes including a first node configured to: receive a speculative message from a second node of the plurality of nodes; receive, within a fixed number (N) of clock cycles after receiving the speculative message, an override message from the second node, the override message including a message identifier indicating a correspondence of the override message with the speculative message; dispatch, during a first clock cycle, the speculative message to a third node of the plurality of nodes; and dispatch, based on the message identifier indicating the correspondence and during a second clock cycle that follows the first clock cycle by the fixed number (N) of clock cycles, the override message to the third node.

In some aspects, the techniques described herein relate to a network connecting a core and a cache of a processor, the network including a plurality of nodes including: a first node configured to: receive a speculative message, receive, within a fixed number (N) of clock cycles after receiving the speculative message, an override message, the override message including a message identifier indicating a correspondence of the override message with the speculative message, dispatch, during a first clock cycle, the speculative message, and dispatch, based on the message identifier indicating the correspondence and during a second clock cycle that follows the first clock cycle by the fixed number (N) of clock cycles, the override message; a second node configured to: dispatch, during a third clock cycle prior to the first clock cycle, the speculative message to the first node, and dispatch, during a fourth clock cycle that is the fixed number (N) of clock cycles after the third clock cycle, the override message to the first node; and a third node configured to: receive, during a fifth clock cycle, the speculative message from the first node, and receive, no later than a sixth clock cycle that follows the fifth clock cycle by the fixed number (N) of clock cycles, the override message from the first node.

Other implementations may perform similar functions as described above and/or may use other types of hardware to perform the functions. Certain implementations may involve systems, devices, media, and/or combinations of these, that employ processors such as described herein (e.g., with cores, caches, and/or networks configured to employ speculative messaging for memory transactions and coupled transmission of such messages in the ways described herein).

The details of these and other implementations are set forth in the accompanying drawings and the description below. Other features will also be made apparent from the following description, drawings, and claims.

### BRIEF DESCRIPTION OF THE DRAWINGS

FIG. 1 shows certain aspects of an illustrative implementation of speculative messaging for memory transactions in a processor in accordance with principles described herein.

FIG. 2 shows an illustrative method to implement speculative messaging for memory transactions in a processor in accordance with principles described herein.

FIG. 3 shows certain timing aspects of an implementation of speculative messaging for memory transactions in a processor in accordance with principles described herein.

FIG. 4 shows various examples of how a speculative message and a corresponding override message may be implemented in accordance with principles described herein.

FIG. 5 shows certain aspects of an illustrative implementation of coupled transmission of memory transaction messages in a processor in accordance with principles described herein.

FIG. 6 shows certain aspects of an illustrative processor that includes a network connecting a cache to a plurality of cores in accordance with principles described herein.

FIG. 7 shows certain aspects of an illustrative transmission node and multi-channel communication between the transmission node and other nodes of the network in accordance with principles described herein.

FIG. 8 shows certain aspects of an illustrative message transmission in which a speculative message is modified by an override message coupled with the speculative message in the transmission in accordance with principles described herein.

FIG. 9 shows certain aspects of an illustrative message transmission in which a speculative message is validated such that no override message is needed for the transmission in accordance with principles described herein.

FIG. 10 shows an illustrative method for coupled transmission of memory transaction messages that may be performed by a transmission node within a processor in accordance with principles described herein.

FIG. 11 shows an illustrative method for coupled transmission of memory transaction messages that may be performed by a core within a processor in accordance with principles described herein.

FIG. 12 shows an illustrative method for coupled transmission of memory transaction messages that may be performed by a cache within a processor in accordance with principles described herein.

FIG. 13 shows an illustrative computing device that may use one or more processors such as those described herein.

### DETAILED DESCRIPTION

Systems and methods for speculative messaging for memory transactions in a processor are described herein, along with corresponding systems and methods for coupled transmission of such memory transaction messages. When a processor core (e.g., a Load/Store Unit (LSU) or other execution unit of the core) sends a memory transaction message to a cache (e.g., a level-2 (L2) cache shared by multiple cores), the message would typically be constructed and fully validated prior to being dispatched. While this full validation may take several clock cycles to accomplish, it may usually be the case that an initial speculation that can be arrived at much more quickly (e.g., a default, an assumption, a prediction, etc.) turns out to be correct. Accordingly, as detailed herein, message construction and transmission may be significantly accelerated (e.g., saving several clock cycles per message in certain cases) by sending speculative messages coupled, in the relatively infrequent event that post-dispatch validation disagrees with the previously-dispatched speculative message, with override messages that allow for corrections to be made prior to the memory transaction being performed erroneously. Moreover, along with generating speculative messages (which will be understood to contain be at least partially unvalidated and/or to include at least one speculative parameter) and corresponding override messages (which contain validated parameters configured to modify the speculative messages), methods and systems described herein also relate to transmitting speculative and override messages in a manner that allows the messages to remain functionally coupled or synchronized as they move through a network between the core and the cache of a processor.

Processors (e.g., central processing units (CPUs)) operate by executing instructions and processing data that may be loaded from main memory and/or obtained from other sources. For example, an address space may include many billions or more physical addresses that may be mapped not only to normal memory resources (e.g., dynamic random-access memory (DRAM)) but also to memory-mapped input/output devices that are accessible via physical memory addresses within the same address space. For example, memory-mapped devices could include graphics processing units (GPUs) (including framebuffers and command registers that may be memory-mapped), network interface cards (NICs) (including transmit/receive buffers and status/control registers that may be memory-mapped), hard drive controllers (including command queues and data buffers that may be memory mapped), universal serial bus (USB) controllers (including endpoint buffers and control registers that may be memory mapped), timer registers, interrupt control registers, peripheral devices (e.g., sound cards, I/O devices such as mice and keyboards, etc.), and so forth.

For the processor to execute the instructions of a particular application and to manipulate and/or process data from main memory or provided by any of these or other memory-mapped devices, the data first may be accessed and brought into one or more processor cores where various types of execution units may perform different tasks to execute the instructions and process the data in accordance with the application. Moreover, after the instructions have been executed and data has been processed within the processor cores, the data may be stored back into memory or provided to the memory-mapped devices.

In any of these cases (e.g., loading data or storing data), processor cores may access the instructions and data by way of one or more levels of caches configured to accelerate data access for the processor with respect to main memory and one or more memory-mapped devices. For example, in a multi-core processor, each core could have a local level-1 (L1) cache that is dedicated to that particular core (i.e., not shared with other cores) and that serves as a relatively small and fast (i.e., low-latency) staging buffer for incoming and outgoing data processed by that core. Multiple cores may then share access to a level-2 (L2) cache that serves as a larger but slower (i.e., higher-latency) staging buffer for incoming and outgoing data processed by all the cores. In some cases, the L2 cache may further connect to even higher levels of cache (e.g., an L3 cache, etc.) or, as will be assumed for examples described herein, the L2 cache may itself be responsible for interfacing with a memory controller (i.e., main memory) and/or various memory-mapped devices such as described above.

A given processor core may use a Load/Store Unit (LSU) to execute memory management instructions such as load instructions (loading or reading data from a particular memory address), store instructions (storing or writing data to a particular memory address), and the like. As used herein, when a core (i.e., a processor core) is described as performing tasks in furtherance of such instructions (e.g., generating and dispatching messages to a cache, etc.), it will be understood that these tasks may be performed by an LSU within the core.

When a given instruction (e.g., a load instruction, a store instruction, etc.) calls for a memory transaction (e.g., retrieving data from memory, storing data to memory, obtaining data from a device, setting parameters of a device, etc.) the core may achieve the memory transaction by communicating messages to a cache (e.g., an L2 cache) that is configured to perform the desired transaction in accordance with information in the message. For example, the message may include a request to perform the memory transaction. This request may include certain parameters and/or other data such as, without limitation: 1) a physical address that has been determined based on a virtual address and that the cache is to use to access normal memory or a memory-mapped device (depending on the address); 2) an access type indicating, for instance, whether shared access (e.g., for a read or load transaction) or exclusive access (e.g., for a write or store transaction) is requested for the memory transaction; 3) a memory type to indicate whether the memory is, for instance, cacheable memory, non-cacheable memory, or device memory (e.g., buffers or registers of a particular device that are mapped to the memory address); 4) a security indicator to indicate whether the address is in a secure portion of the address space and/or whether there is authorization for the address to be accessed; 5) parameters to indicate whether a snoop to the local (L1) cache is to be performed (e.g., whether the physical address for the memory transaction hits in the L1 cache and/or whether the entry is to be replaced, cleaned out, or reconciled in the L1 cache); and so forth.

One technical problem that occurs when a memory management instruction is to be executed is that it may take several clock cycles for the core to generate and validate the message that is to be sent to the cache in furtherance of the desired memory transaction. For example, the core may perform address translation tasks (e.g., to determine, from a virtual address used by the software instructions, the physical address that is to be included within the message), interact with the L1 cache (e.g., to determine if the data is already available from the L1 cache), make other determinations (e.g., regarding the access type for the address, the memory type for the address, the security status of the address, etc.), and so forth. All of these tasks may take time (e.g., one or more clock cycles that may or may not be able to be performed in parallel with the other tasks), such that the total number of clock cycles used to construct a memory transaction message may contribute a significant portion of the total transaction time. For example, the message generation and validation time could be 4 clock cycles, 5 clock cycles, 6 clock cycles, 8 clock cycles, 10 clock cycles, or the like, followed by several more (e.g., 2, 5, 10, 20, etc.) clock cycles for the message to be communicated across a multi-node network connecting the core and the cache for which the message is intended.

At least one technical solution described herein to address this problem (i.e., to speed up the time it takes for a message to be generated by the core and transmitted to the cache) involves dispatching, from the core to the cache, a message that is speculative (i.e., a message that is at least partially unvalidated). For example, such speculative messaging may rely on default assumptions that tend to hold true for most messages or may involve more provisional (and fast) determinations that can later be double-checked during a more through validation of the message (e.g., an initial prediction, a most-probable value, etc.). In some cases, a message may be dispatched as soon as certain key parameters (e.g., the physical address) are determined and validated, even if other parameters (e.g., a snoop decision for the local L1 cache, an access type, a memory type, a security indicator, etc.) are not yet fully validated. In certain examples, even the physical address may not be fully validated at the time of dispatching a speculative message. In any case, a speculative message may include portions that are not yet fully validated when the message is dispatched, and this may allow the speculative message to be dispatched earlier (e.g., one or more clock cycles earlier) than it would otherwise be dispatched.

By taking a shortcut on the validation of certain aspects of a memory transaction message, the message may be dispatched one or more clock cycles sooner than if the core held off on the transmission until all the parameters had been fully validated. This may provide a significant performance improvement since there may be a large number of such messages being constructed and sent during processor operation and these few clock cycles can represent a meaningful percentage of the overall transaction time. Even if the speculative parameters can be determined in a manner that is correct a high percentage of the time (e.g., more often than not, 90% of the time, 99% of the time, etc.), however, an additional technical problem arises when this shortcut is applied since, by their nature, unvalidated, speculative parameters are bound to be incorrect at least occasionally. If this scenario occurred without correction, it could result in a significant performance penalty or even a functional error.

Accordingly, to address this technical problem of certain speculative parameters being discovered to be incorrect after a message incorporating them has already been sent out, methods and systems for coupled transmission of memory transaction messages are described herein that allow for memory transactions requested using at least some speculation as to the parameters of the transactions (also referred to as speculative cache transactions) to be modified before a significant performance penalty or functional error occurs.

More specifically, as detailed below, a source node on the network (e.g., a processor core) may dispatch a speculative message that is at least partially unvalidated. Such speculative messages are also referred to herein as primary messages and will be understood to include at least one speculative parameter or other aspect that has not been fully validated. It will be understood that, while speculative messages are at least partially unvalidated when they are dispatched, they may not be completely unvalidated. For example, the speculative (or primary) message may also include one or more validated parameters. In one example, for instance, a physical address could be determined and validated and included within a speculative message, while an access type and a memory type may be speculative (i.e., not yet fully validated) when the speculative message is dispatched. One or more clock cycles later, when validation is complete for the dispatched speculative message (e.g., when the access type and the memory type in the example above have been fully validated), it may be discovered that one or more speculative parameters were incorrect or the message otherwise is to be modified. Accordingly, an override message may be dispatched to follow the speculative message through the network to the cache. In this way, when the endpoint node (e.g., the cache) receives the speculative message, work may begin to perform the memory transaction as directed by the speculative message, then that work can be modified as appropriate (e.g., overridden, supplemented, changed, redone, canceled, etc.) in accordance with the override message when it arrives (e.g., a few clock cycles later, as will be described).

Beneficial technical effects may arise from this approach of dispatching speculative messages prior to their being fully validated (i.e., using speculative parameters to dispatch messages earlier than a full validation of the parameters would allow). This is especially true when the assumptions built into the speculative parameters can be made accurately so that modification using override messages is relatively rare. When no modification (e.g., correction, cancelation, etc.) is needed, the memory transaction receives a performance boost of one or more clock cycles that were conserved by getting the prospective parameters on their way even before they were validated. This technical effect may be multiplied to all the memory transaction messages sent between the various cores and the cache to result in a significant performance increase for the processor (e.g., accessing memory and devices with less latency, more efficiency, less power, etc., and completing more instructions in a shorter period of time).

However, another technical problem arises when incoming speculative messages are not guaranteed to be correct, since significant performance penalties and even erroneous functionality could result from speculative messages with inaccurate parameters being performed without accounting for follow-up override messages. One technical solution to this problem could be to flush the operations whenever a speculative parameter is detected that needs to be corrected. This may be an inefficient and difficult way to address the problem, however, since flushing an operation in a system as complex as the cache may require considerable design provisions that result in inefficiently flushing several operations and invoking a more consequential performance penalty than the saved cycles can justify. Another technical solution to this problem could be to follow every speculative message with either an acknowledge message (indicating that the parameters in the speculative message were ultimately validated to be correct) or an override message that indicates modifications to be made (e.g., validated parameters configured to correct any inaccuracies that the parameters of the speculative message possesses). This solution, however, may result in a huge number of acknowledge messages that could flood the network (essentially doubling the number of messages it has to carry) and increase traffic to an extent that the benefits of sending speculative parameters a few cycles early may not justify.

These pitfalls of broadly flushing operations in a complex cache system and/or choking the network with acknowledge messages for every speculative message whose parameters turn out to be accurate may be avoided by technical solutions described herein. For example, at least one technical solution described herein involves sending override messages a fixed number of clock cycles behind their corresponding speculative messages and not sending any follow-up message (either to override or explicitly acknowledge) when a speculative message with speculative parameters is later fully validated and discovered to be accurate. In this way, when the cache receives a speculative message and the fixed number of clock cycles passes without a corresponding override message being received, the parameters within the speculative message can be safely inferred to be fully validated and the transaction may be completed.

One challenge to implementing this technical solution, however, is that the timing and data path of messages traveling through the network connecting the processor cores and the cache may be unpredictable and irregular. As will be described in more detail below, a speculative message and its corresponding override message may traverse the network via a same data path (e.g., originating at the same source node and passing through the same transmission nodes to ultimately arrive at the same endpoint node). However, the different types of messages may travel this data path in different communication channels that have different amounts of traffic and delay. Implementations described herein are therefore configured to ensure that, whatever delay a speculative message may face as it traverses the network via a particular data path, any corresponding override message for that speculative message will follow the speculative message on the same data path (although possibly using a different communication channel) to arrive at each node no later than a fixed number of clock cycles after the speculative message.

As used herein, a network connecting one or more cores to a cache may include three types of network nodes. First, source nodes refer to those nodes that originate messages that are to be communicated via the network. For instance, each of the one or more cores may be referred to as a source node in examples herein. Second, an endpoint node refers to a final node to which messages are to be delivered. For instance, a shared L2 cache may serve as an endpoint node to which various source nodes (e.g., processor cores) may communicate messages. Third, transmission nodes refer to the remainder of the network nodes that neither source new messages nor are the final destination for the messages, but, rather, are configured to transmit the messages along through the network toward their destination. These transmission nodes may be arranged in any suitable topology (e.g., a point-to-point topology, a mesh topology, a ring topology, a star topology, a tree topology, a hybrid topology incorporating elements of two or more of these, etc.) to connect a plurality of source nodes (e.g., a plurality of different cores generating their own messages in a multi-core processor) to an endpoint node (e.g., the cache). As a result, while a speculative message and its corresponding override message may traverse the network via a same data path, that data path through the network may be somewhat unpredictable (e.g., depending on other network traffic at the time) and the times it takes for the message to traverse the network to arrive at the destination may be variable (e.g., taking anywhere from 5 to 20 clock cycles, depending on other network traffic and behavior, in one example).

Due to this network variability, technical solutions described herein involve ways to not only guarantee the fixed number of clock cycles between a speculative message and its corresponding override message when it is dispatched by the source node (e.g., when it is generated and sent by the core), but also maintaining the fixed number of clock cycles at each transmission node within the network that the coupled messages pass through. This fixed number of clock cycles will be referred to herein as N, and it will be understood that N may represent the number of clock cycles needed to finish fully validating information that is included within speculative parameters sent out in speculative messages. For example, if a design is such that 2 cycles are always taken to validate a physical address (which, in this example, may be validated and included in the speculative message) and an additional 3 cycles are always taken to validate other parameters such as a snoop request, access type, memory type, security indicator, or the like (which, in this example, may be included in the speculative message without being fully validated), N would be 3 in this example. Conversely, if a design is such that the number of clock cycles varies from transaction to transaction (e.g., taking a minimum of 2 cycles and a maximum of 4 cycles to validate the other parameters), N could be the maximum number of cycles (e.g., 4 in this example). It will be understood that these examples of N are given only as examples and that N may be any suitable integer, one or greater, as may serve a particular implementation.

As will be described in detail below, each node of the network (e.g., the source node and each transmission node on a particular data path through the network from the source node to the endpoint at the cache) may maintain N cycles between when the speculative message is dispatched to the next node and when the corresponding override message is dispatched to follow it. In this way, even when significant variability enters into the picture (as will be described), this synchronous coupling of the messages allows for the beneficial technical effects described above (e.g., reducing the transaction time by N cycles for accurately speculated messages without risk of significant performance penalties or erroneous functionality for messages whose speculations turn out to be inaccurate) while avoiding various pitfalls and shortcomings of alternative approaches that have been mentioned.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Speculative messaging for memory transactions in a processor and coupled transmission of speculative and override messages in accordance with principles described herein may result in any or all of the technical effects mentioned above, as well as various additional and/or alternative beneficial technical effects described and/or made apparent below.

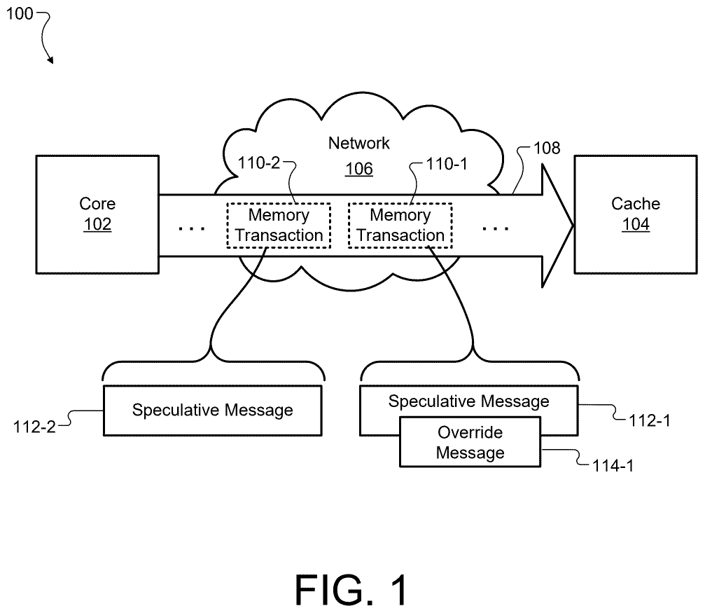

FIG. 1 shows certain aspects of an illustrative implementation 100 of speculative messaging for memory transactions in a processor in accordance with principles described herein. As shown in implementation 100, a core 102 (e.g., one core of a multi-core processor) may send messages to a cache 104 (e.g., an L2 cache shared by multiple cores, only one of which is shown in FIG. 1) by way of a network 106. As will be described in more detail below, core 102 (and other cores of the processor not explicitly shown) may include a local cache separate from cache 104 to which speculative messages are dispatched. This cache will be referred to as a local cache or an L1 cache and will be understood to be different from the shared, L2 cache represented by cache 104.

Coupled speculative messages and override messages may be dispatched from core 102 to be carried to cache 104 via the network 106 connecting core 102 and cache 104. As will be further described and illustrated below, this network 106 may include a plurality of nodes, and, as shown in FIG. 1, a data path 108 from core 102 to cache 104 (through nodes of network 106) may be used to transmit a plurality of memory transactions 110-1, 110-2, and so forth.

Core 102 and cache 104 may be included within a processor such as a CPU. Cache 104 may be configured to perform memory transactions, while core 102 may be configured to direct the memory transactions by providing speculative messaging for the memory transactions in accordance with principles described herein. For example, core 102 may perform a process comprising: 1) dispatching, to cache 104, a speculative message 112-1 configured to direct cache 104 to begin performing memory transaction 110-1 (where speculative message 112-1 is at least partially unvalidated, as has been described); 2) determining a modification to speculative message 112-1 during a validation of speculative message 112-1 after it has been dispatched; and 3) dispatching, to cache 104 and in response to the determining of the modification, an override message 114-1 indicating the modification.

Additionally (and, as mentioned above, more commonly in many implementations), core 102 may perform additional process steps for speculative messages that do not ultimately call for modification from override messages. For example, the process described above to be performed by core 102 may further include: 4) dispatching, to cache 104, a speculative message 112-2 configured to direct cache 104 to begin performing memory transaction 110-2 (this speculative message 112-2 also being at least partially unvalidated when dispatched); 5) determining, during a validation of speculative message 112-2 after the dispatching of speculative message 112-2, that speculative message 112-2 is valid without modification; and 6) in response to the determining that speculative message 112-2 is valid without modification, abstaining from dispatching any override message associated with speculative message 112-2.

Each of the memory transactions requested by core 102 (e.g., memory transactions 110-1, 110-2, etc.) may represent any suitable type of memory transaction. For example, any given memory transaction could be implemented as a load transaction to obtain data associated with a particular physical address (e.g., a memory address within normal memory, a device address mapped to the physical address space, etc.), a store transaction to write data to a particular physical address, or another suitable memory transaction. Various examples of the types of parameters and information included in the messaging to request and implement such transactions will be provided below. Additionally, more detail about how speculative and override messages (such as speculative message 112-1 and override message 114-1) may be coupled or synchronized as they travel through network 106 will also be described below.

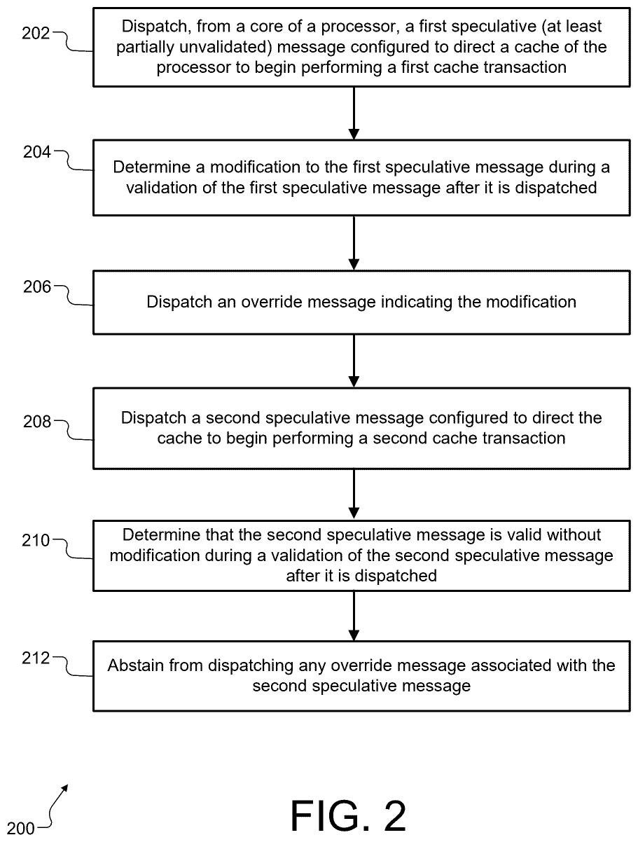

FIG. 2 shows an illustrative method 200 to implement speculative messaging for memory transactions in a processor in accordance with principles described herein. Like the process described above in relation to FIG. 1, method 200 may be performed by a core of a processor that is communicatively coupled to a cache of the processor by way of a network (e.g., a core such as core 102 illustrated in FIG. 1). While FIG. 2 shows illustrative operations according to a specific implementation, it will be understood that other implementations of these methods may omit, add to, reorder, and/or modify any of the operations that are explicitly represented in FIG. 2. Additionally, while the operations of method 200 are illustrated with arrows suggestive of a sequential order of operation, it will be understood that one or more of the operations of method 200 may be performed concurrently (e.g., in parallel) with one another. Method 200 will now be described in more detail.

At operation 202, the core may dispatch, from the core to the cache of the processor, a first speculative message. The speculative message may be at least partially unvalidated, such as by including, for instance, certain speculative parameters (e.g., default parameters, predicted parameters, parameters that have been more quickly determined but not yet fully vetted, etc.). Even though this speculative message could end up being modified when the full validation is complete, the speculative message may be configured to direct the cache to begin performing a first memory transaction. In other words, the cache may receive and begin performing the first memory transaction one or more cycles earlier than if it had to wait for the message to be fully validated.

At operation 204, the core may determine a modification to the first speculative message. For example, the modification may be determined by the core during a validation of the first speculative message after it has already been dispatched at operation 202. The modification determined at operation 204 could be a correction to a speculative aspect of the speculative message dispatched at operation 202 that has been discovered to be incorrect. In certain cases, the speculative message as dispatched at operation 202 may have a big enough problem (e.g., an incorrect physical address) that the modification causes the memory transaction to be canceled entire. Additionally or alternatively, the speculative message could have been correct, and the modification could take advantage of the coupled transmission architecture to increase the efficiency of the processor by retroactively modifying the memory transaction to better prepare the way for a later memory transaction. Examples of such modifications will be provided and described in more detail below.

At operation 206, the core may dispatch an override message indicating the modification determined at operation 204. For example, the generation and dispatch of the override message may be performed in response to the determining of the modification at operation 204. As mentioned, the modification indicated in the override message may be configured to direct the cache to modify the speculative message request (i.e., modify how the memory transaction is being performed) in a variety of ways and for a variety of reasons that will be described in more detail below.

In the event that an override message is dispatched for a memory transaction (such as described above in relation to operation 206) and the cache alters the actions it performs for the memory transaction, the benefits of the speculative messaging (e.g., the cache getting a head start of a few cycles on performing the memory transaction) may be reduced or nonexistent. In some cases, the modification performed when the override message is received may even come at a cost of one or more cycles. However, it will be understood that these consequences and costs may be easily justified by the fact that an occasional override message allows for many other speculative messages to be performed with a head start that never has to be replayed. To illustrate, operations 208-212 relate to the processing of a second memory transaction that may represent a more common scenario and may provide the benefits of the conserved clock cycles (i.e., the head start provided by dispatching the memory transaction request as a speculative message) more fully. This second memory transaction is made possible by the fact that, when a speculation does result in a modification (e.g., as described for the first memory transaction in relation to operations 202-206), provisions are in place for the modification to be carried out.

At operation 208, the core may dispatch the second speculative message, which, like the first speculative message described above, may also be at least partially unvalidated. The second speculative message may be configured to direct the cache to begin performing a second memory transaction.

At operation 210, the core may determine, during a validation of the second speculative message after it has been dispatched at operation 208, that the second speculative message is valid without modification. This is different from operation 204, where the first speculative message was determined to need modification, such that an override message had to be dispatched at operation 206. As mentioned above, this latter scenario may be more common and may be associated with significant benefits, though the modification mechanisms described in relation to the first memory transaction may allow for these benefits by ensuring that there is never a situation where a memory transaction is processed erroneously as a result of the speculative messaging.

At operation 212, the core may abstain from dispatching any override message associated with the second speculative message. For example, in response to the determining at operation 210 that the second speculative message is valid without modification, the core may simply move on to additional tasks (e.g., messaging for another memory transaction, etc.) without needing to dispatch any override message in relation to the second speculative message.

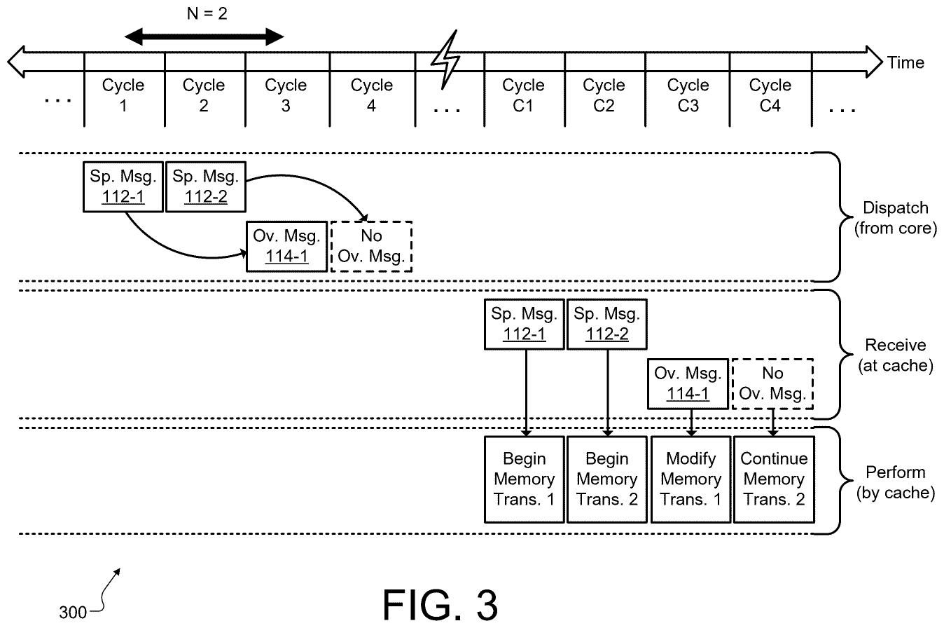

FIG. 3 shows certain timing aspects of an implementation 300 of speculative messaging for memory transactions in a processor in accordance with principles described herein. In general, and as will be described in more detail below, the processor may be configured such that the core and each transmission node along data path 108 of network 106 may ensure a certain timing relationship between a speculative message and a corresponding override message. More particularly, if the dispatching of a speculative message is performed during a first clock cycle, the core and the transmission nodes may ensure that the dispatching of the override message is performed during a second clock cycle that follows the first clock cycle by a predetermined fixed number N of clock cycles, where N could equal 1, 2, 3, 4, or another suitable number of clock cycles. Messages that are made to adhere to this timing relationship will be referred to herein as being coupled in their transmission across the network, and additional details as to how such coupled transmission may be implemented in various circumstances will be described below.

FIG. 3 specifically shows the timing relationship for the speculative message 112-1 and override message 114-1 described above (which are to be coupled in their transmission over network 106), as well as the processing of speculative message 112-2, which, as mentioned, does not receive a corresponding override message. Due to space constraints, speculative messages are abbreviated as “Sp. Msg.” in FIG. 3 and override messages are abbreviated as “Ov. Msg.” Memory transactions are also abbreviated in the figure (“memory trans.”). The specific example of implementation 300 is shown to set the fixed number N of clock cycles to 2 (“N=2”). As has been mentioned, however, it will be understood that N could be another suitable number in other examples and the relationship between speculative messages and corresponding override messages would be altered accordingly.

A timeline at the top of FIG. 3 shows various clock cycles labeled as Cycle 1, Cycle 2, and so forth. As shown, speculative message 112-1 is dispatched from the core at Cycle 1, while speculative message 112-2 is dispatched from the core at Cycle 2 (the subsequent clock cycle).

N cycles after Cycle 1 (i.e., at Cycle 3, since N=2 in this example), the core is shown to dispatch override message 114-1, which, as has been described and as illustrated by an arrow, will be understood to correspond to speculative message 112-1. For example, override message 114-1 may indicate a modification to speculative message 112-1 that was determined during a validation of speculative message 112-1 that was performed after speculative message 112-1 had been dispatched (e.g., during Cycle 2 and Cycle 3).

N cycles after Cycle 2 (i.e., at Cycle 4, since N=2 in this example), the core is shown to abstain from dispatching any override message associated with speculative message 112-2 (“No Ov. Msg.”). As described above, this abstention from dispatching an additional override message may be in response to a determination, during a validation of speculative message 112-2 after speculative message 112-2 has been dispatched (e.g., during Cycle 3 and Cycle 4), that speculative message 112-2 is valid without modification.

An omission mark (i.e., lightning bolt symbol) is shown on the timeline to represent some number of clock cycles during which the messages dispatched during Cycles 1-3 traverse the network toward the cache (more details of which will be provided below). After this traversal, further clock cycles on the timeline are labeled with a ‘C’ to represent clock cycles at the cache (i.e., Cycle C1, Cycle C2, etc.).

As shown at Cycle C1, when the cache receives speculative message 112-1, the cache may begin to perform the first memory transaction (e.g., memory transaction 110-1) requested by speculative message 112-1 (“Begin Memory Trans. 1”). Similarly, when the cache receives speculative message 112-2 during the subsequent Cycle C2, the cache may begin to perform the second memory transaction (e.g., memory transaction 110-2) requested by speculative message 112-2 (“Begin Memory Trans. 2”). While the receiving of the message and the consequent performing of the request is shown to take place during the same clock cycle in this figure, it will be understood that the message could be received during one clock cycle and begin to work on the request on the subsequent cycle in certain implementations.

N cycles after Cycle C1 (at Cycle C3 in this example, since N=2), the cache is shown to receive override message 114-1. In response, the cache may modify the first memory transaction that it began performing at Cycle C1 (“Modify Memory Trans. 1”). This modification may take a variety of forms, as will be described in more detail below. N cycles after Cycle C2 (at Cycle C4 in this example, since N=2), implementation 300 shows that the cache has not received any override message corresponding to speculative message 112-2 (“No Ov. Msg.”). Since the coupled transmission is configured to guarantee any override message to have been received by this clock cycle, the cache may therefore safely assume that speculative message 112-2 is valid without modification. Accordingly, as shown, the cache may continue performing the second memory transaction that it began performing at Cycle C2 (“Continue Memory Trans. 2”), having benefited from a N-cycle (i.e., 2-cycle in this example) head start in the performing of the transaction.

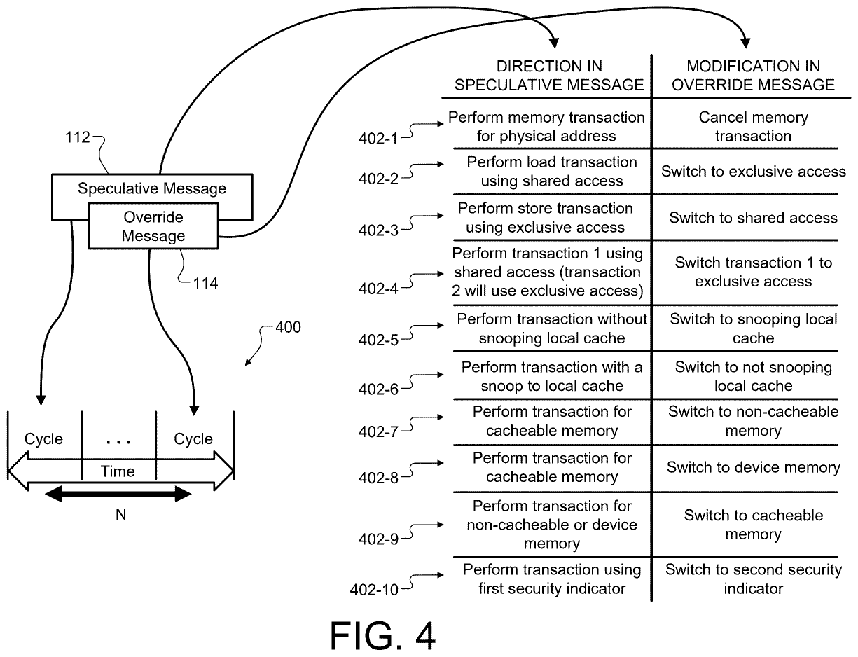

FIG. 4 shows various examples of how a speculative message and a corresponding override message may be implemented in accordance with principles described herein. More particularly, FIG. 4 shows a speculative message 112 and a corresponding override message 114, which will be understood to implement speculative message 112-1 and override message 114-1 described above, or another suitable coupling of a speculative message and an override message as may serve a particular example. Arrows from speculative message 112 and override message 114 to a timing diagram 400 drawn below the messages shows that, as has been described, the dispatching of speculative message 112 may be performed during a first clock cycle, while the dispatching of override message 114 may be performed during a second clock cycle that follows the first clock cycle by a predetermined fixed number N of clock cycles. An ellipsis illustrates that N may be 2 (such as the example illustrated above) or another suitable number one or more as may serve a particular implementation.

A chart next to speculative message 112 and override message 114 in FIG. 4 shows ten examples 402-1 through 402-10 of direction that speculative message 112 could provide for a memory transaction and the corresponding modification that override message 114 could provide N clock cycles later. Each of these examples 402-1 through 402-10 will now be described in more detail.

In example 402-1, speculative message 112 is shown to direct the cache to perform the memory transaction for a particular physical address, while override message 114 is shown to direct the cache to cancel the memory transaction as a result of the physical address being incorrect. For instance, speculative message 112 may include a physical address for the memory transaction; the validation of speculative message 112 may include determining that the physical address is incorrect (e.g., as a result of being computed incorrectly, being mistranslated based on stale data, or the like); and the modification indicated in override message 114 may be configured to direct the cache to cancel the memory transaction (e.g., since a new memory transaction using the correct physical address will presumably be requested).

In example 402-2, speculative message 112 is shown to direct the cache to perform a load transaction (e.g., a memory transaction in which data is obtained from memory or a device) using a shared access type, while override message 114 is shown to direct the cache to instead use an exclusive access type for the transaction. For instance, speculative message 112 may indicate that the memory transaction is a load transaction associated with a shared access type; the validation of speculative message 112 may include determining that the memory transaction is actually a store transaction associated with an exclusive access type; and the modification indicated in override message 114 may direct the cache to replace the shared access type with the exclusive access type for the memory transaction.

Different access types such as shared and exclusive access are included in memory transaction requests due to the different consequences of reading and writing data and based on an assumption that other cores besides the one requesting the memory transaction in question may be operating independently and could perform instructions that touch the same physical addresses. For example, since the act of reading (or loading) a chunk of data (e.g., a cache line) from a particular physical address does not alter or affect the data, multiple cores may simultaneously read this data without a need for the data to be reconciled and without risk of one core altering the data in a manner that adversely affects the operations being performed by another core. For read operations (e.g., load transactions from memory or device registers), a shared access type (also referred to read share access) may be used to optimize the use of that particular data. In other words, if one core does not plan to change the data at a physical address, it may access the data in a manner that allows other cores to also concurrently access and read the data (rather than making them wait, which could be unnecessary and inefficient).

In contrast, since the act of writing (or storing) a chunk of data (e.g., a cache line) to a particular physical address does alter and affect what is stored at that address, only one core at a time may write the data so as to ensure that there are not conflicts between cores accessing the same addresses at the same time. For write operations (e.g., store transactions to memory or device registers), an exclusive access type (also referred to read exclusive access) may therefore be used to ensure that only the core writing to the address can access it while the transaction takes place. In other words, if one core plans to change the data at a physical address, it may access the data in a manner that ensures no other cores are able to concurrently access and write to the address until the exclusive access is relinquished (after which snooping and proper reconciliation procedures may be performed by the L2 cache to ensure that all the cores use the most up-to-date version of the data).

Example 402-3 may then be the opposite of example 402-2, moving the other direction from exclusive to shared access. More specifically, in example 402-3, speculative message 112 is shown to direct the cache to perform a store transaction (e.g., a memory transaction in which data is written to memory or a device) using an exclusive access type, while override message 114 is shown to direct the cache to instead use a shared access type for the transaction. For example, speculative message 112 may indicate that the memory transaction is a store transaction associated with an exclusive access type; the validation of speculative message 112 may include determining that the memory transaction is actually a load transaction associated with a shared access type; and the modification indicated in override message 114 may direct the cache to replace the exclusive access type with the shared access type for the memory transaction.

In example 402-4, speculative message 112 is shown to direct the cache to perform a first memory transaction (“transaction 1”) using shared access. In this example, it is also parenthetically noted that a separate speculative message for a second memory transaction (“transaction 2”) follows speculative message 112 (e.g., within N cycles such that the request comes prior to or concurrent with an override message for speculative message 112). This second speculative message is indicated to request exclusive access. As such, in this scenario, the override message 114 is shown to direct the cache to request the exclusive access for the first memory transaction, rather than the shared access requested in the speculative message 112.

More particularly, in the scenario of example 402-4, the core may determine, during the validation of speculative message 112 (after speculative message 112 has already been dispatched), that speculative message 112 is valid without modification. After sending out speculative message 112 for the first memory transaction and during the validation of speculative message 112, the core may determine that an additional memory transaction is requested for a same physical address as the first memory transaction and this additional memory transaction may have a different access type. For instance, the first memory transaction may be associated with a first access type (e.g., shared access), while the additional memory transaction is associated with a second access type different from the first access type (e.g., exclusive access). Accordingly, the modification indicated in override message 114 may direct the cache to replace the first access type with the second access type for the first memory transaction.

This example is different from various other examples described herein in that it does not necessarily involve a speculative parameter having been sent out and later being determined to be incorrect. Indeed, when the speculative message 112 is sent out to request the first memory transaction using the first access type, that first access type may indeed be correct for the first memory transaction (e.g., the first memory transaction may be a load transaction, and the first access type may be a shared access type that is appropriate for that type of transaction). In this case, override message 114 is provided for a different reason than to correct the speculative message 112 for the first memory transaction. Specifically, example 402-4 relates to a situation in which, soon after the first memory transaction, a second memory transaction is requested for the same physical address but with a different access type.

For instance, this scenario could occur if the core directed a particular memory address to be loaded and then stored soon after. While the load transaction in this scenario only needs shared access to read the address, efficiency may be gained by leveraging the coupled transmission mechanism when it is discovered that a store transaction (for which exclusive access will be requested to that address) immediately follows the load. Specifically, rather than allowing the first memory transaction (i.e., the load transaction in this example) to proceed just to then request the same address with a different type of access soon after, an override message may be used to direct the cache to perform the first memory transaction using the second access type (e.g., to perform the load transaction using exclusive access rather than shared access). While this is not strictly necessary, it may help conserve clock cycles and otherwise produce efficiency for the processor to gain, for the earlier transaction (i.e., the load in this example, which can be performed equally well with either access type), the exclusive access it will soon need for the later transaction (i.e., the store in this example, which requires the exclusive access).

In example 402-5, speculative message 112 is shown to direct the cache (e.g., the L2 cache) to perform a memory transaction without snooping the local cache (e.g., the L1 cache dedicated to the requesting core), while override message 114 is then shown to direct the cache to snoop the local cache after all. Depending on default presumptions built into a particular implementation, for instance, this directing of the cache to perform the memory transaction without snooping the local cache could be achieved either by providing an express request that the cache not perform the snoop (if the default is that the snoop is to be performed) or by abstaining to provide an express request that the cache should perform the snoop (if the default is already that the snoop is not to be performed). In either case, for this example, the speculative message lacks a request for (i.e., does not request) the cache to snoop the local cache as part of the memory transaction. However, if the validation of speculative message 112 then includes determining that the local cache includes an entry for the physical address, the modification indicated in override message 114 may include a request for the cache to snoop the local cache for the physical address.

The cache (e.g., the L2 cache) may keep track of what data each of the local caches of each of the cores (e.g., the L1 caches) that share use of the cache are storing locally. In this way, the cache is able to facilitate coordination and reconciliation between the cores as they may read and write to the same memory space. One tool the cache uses in this effort is referred to as a snoop. Specifically, when the cache snoops one of the local caches with respect to a particular address, the snoop requests that the local cache (and the core hosting it) provide the local copy of the data stored in the local cache in preparation for that entry to be rewritten (possibly with the same data if it happened to be the most up-to-date, or possibly with a newer version of the data that was written by a different core). When a memory transaction is requested for a particular physical address, the cache may therefore need to determine whether a snoop is to be performed on the local cache of the core. For example, if the data in question (i.e., data associated with the particular physical address) is stored in an entry of the local cache, a snoop may be appropriate. If, on the other hand, the data in question is not to be found in the local cache, the snoop could be wasteful (since the snoop action takes time and resources to perform).

A speculative message such as speculative message 112 may thus be configured to indicate, for the physical address associated with the memory transaction being requested, whether a snoop is to be performed. For example, if it is determined that the local cache has an entry for that physical address, the snoop may be requested, while if the local cache does not have an entry for that physical address, no snoop may be requested (or it may be explicitly requested that no snoop be performed in certain implementations). Example 402-5 therefore relates to one scenario where the speculation that the core makes with regard to whether a snoop is necessary turns out to be incorrect. Specifically, as described above, in this scenario, the speculative message 112 may indicate that the core does not have an entry for the physical address in question (and thus the cache is not to snoop the local cache as this would be unnecessary and wasteful) while the override message 114 indicates that the core does have the entry after all, and a snoop should be performed.

In example 402-6, on the other hand, an opposite scenario is represented in which the speculative message 112 may indicate that the core does have an entry for the physical address in question, and thus the cache is to snoop the local cache to ensure proper cache integrity and consistency. As shown, speculative message 112 may direct the cache to perform a memory transaction with a snoop to the local cache (e.g., the L1 cache dedicated to the requesting core), while override message 114 is then shown to direct the cache to not bother snooping the local cache after all. For instance, if the core of the processor is associated with a local cache separate from the cache to which the speculative message is dispatched, the speculative message may, in this example, include a request for the cache to snoop, as part of the memory transaction, the local cache for a physical address related to the memory transaction. However, if the validation of speculative message 112 then includes determining that the local cache does not include an entry for the physical address, the modification indicated in override message 114 may direct the cache to ignore the request for the cache to snoop the local cache for the physical address (and to therefore not bother snooping the local cache in this example).

In example 402-7, speculative message 112 is shown to direct the cache to perform a memory transaction for a physical address that is associated with cacheable memory, while override message 114 is shown to direct the cache to instead treat the physical address as being associated with non-cacheable memory. For instance, speculative message 112 may indicate that the memory transaction is associated with a cacheable memory type; the validation of speculative message 112 may include determining that the memory transaction is associated with a non-cacheable memory type; and the modification indicated in override message 114 may direct the cache to replace the cacheable memory type with the non-cacheable memory type for the memory transaction.

As has been mentioned, within the memory space that the memory transactions may be performed within (i.e., the memory space that includes all the possible physical addresses that could be indicated by a memory transaction message), there are different types of memory. As a first example of a memory type, cacheable memory refers to normal memory resources (e.g., dynamic random-access memory (DRAM) resources of main memory, etc.) that have a relatively high likelihood of being used and reused, such that efficiencies can be gained when these addresses are cached. Cacheable memory may be used, for example, to store variables of a software program that are being read, written to, and used in various ways to improve performance of the software by avoiding having to fetch and store the data every time it is used (as accessing data from main memory can take hundreds of clock cycles longer than accessing data from a cache).

As another example of a memory type, non-cacheable memory refers to normal memory resources (e.g., DRAM resources) that have a relatively low likelihood of being used and reused, such that efficiencies are unlikely to be gained by caching these addresses. Non-cacheable memory could be used, for example, to temporarily store large amounts of data that is being moved from one location in memory (e.g., on a USB drive or a hard drive) to another (e.g., loading it into memory, moving it to another device, etc.). If cached, a large data transfer like this could clear out all the other data in the cache and not achieve any efficiencies, since after the transfer, the data is not necessarily accessed again.

As yet another example of a memory type, device memory refers to registers and buffers of memory-mapped devices such as described herein (e.g., a USB device, a GPU device, a hard drive, etc.). Physical addresses within the same address space as normal memory addresses may be used to allow the core to access registers, buffers, and other I/O interfaces of such devices in a unified manner with how normal memory is accessed (i.e., using load transactions and store transactions via the cache). However, it will be understood that these addresses may not actually point to places where stored data can be accessed or where data can be stored. Rather these addresses allow for interaction with devices using registers and buffers that could behave quite differently than regular memory. Accordingly, device memory may be treated differently than other types of memory (e.g., cacheable and non-cacheable memory) and each memory transaction may indicate what type of memory is being accessed by the memory transaction.

Similarly to example 402-7, in example 402-8, speculative message 112 is shown to direct the cache to perform a memory transaction for a physical address that is associated with cacheable memory, while override message 114 is shown to direct the cache to instead treat the physical address as being associated with device memory. For instance, speculative message 112 may indicate that the memory transaction is associated with a cacheable memory type; the validation of speculative message 112 may include determining that the memory transaction is associated with a device memory type; and the modification indicated in override message 114 may direct the cache to replace the cacheable memory type with the device memory type for the memory transaction.

Either of these examples 402-7 or 402-8 may also be reversed to correct the memory type in the opposite direction. More particularly, as illustrated by example 402-9, speculative message 112 may direct the cache to perform a memory transaction for a physical address that is associated with non-cacheable memory or device memory, while override message 114 is shown to direct the cache to instead treat the physical address as being associated with cacheable memory. For instance, speculative message 112 may indicate that the memory transaction is associated with one of a non-cacheable memory type or a device memory type; the validation of speculative message 112 may include determining that the memory transaction is associated with a cacheable memory type; and the modification indicated in override message 114 may direct the cache to replace the non-cacheable memory type or the device memory type with the cacheable memory type for the memory transaction.

In example 402-10, speculative message 112 is shown to direct the cache to perform a memory transaction using a first security indicator, while override message 114 is shown to direct the cache to instead perform the memory transaction using a second security indicator that is different from the first security indicator. For instance, speculative message 112 may indicate that the memory transaction is associated with a first security indicator; the validation of speculative message 112 may include determining that the memory transaction is associated with a second security indicator that is different from the first security indicator; and the modification indicated in override message 114 may direct the cache to replace the first security indicator with the second security indicator for the memory transaction.

Different portions of a memory space may be associated with different types or amounts of security. For example, secured memory may only be accessed by certain entities (e.g., an operating system, etc.) or under certain circumstances (e.g., when proper credentials are provided, etc.). In contrast, unsecured memory may be accessed more freely by numerous entities (e.g., the operating system and other software applications) and under a variety of circumstances (e.g., whenever the software is configured to access it). A security indicator may be explicitly tied to the physical address in certain implementations (e.g., such that the cache would know that security status based on the physical address itself), while a security indicator parameter could be included within the speculative message 112 (as a parameter separate from the physical address) in other implementations. In example 402-10, the security indicator may therefore be changed from the first to the second type of security (e.g., from secured to unsecured memory, or from unsecured to secured memory) in response to the modification in override message 114.

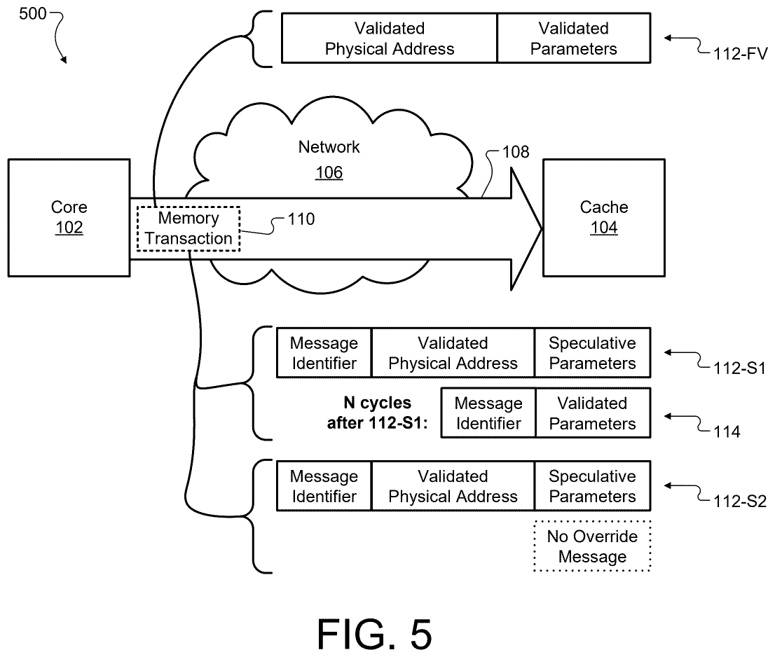

Regardless of the request content included in a particular speculative message 112 example or the modification content included in a corresponding override message 114 example, these messages may be coupled so as to have a predetermined timing relationship both by the source node (i.e., the requesting core) and by each of the transmission nodes of the network that the messages may pass through on their way from the core to the cache. Indeed, as has been described, and as will be further described below, this coupling (i.e., this temporal relationship of no more than N clock cycles) may allow the cache to safely assume that a particular speculative message is not going to be modified by an override message after N cycles have passed without any corresponding override message being received. To further illustrate principles of how the coupled transmission of speculative messages may be performed for memory transactions described herein, FIGS. 5 through 12 will now be described.

FIG. 5 shows certain aspects of an illustrative implementation 500 of coupled transmission of memory transaction messages in a processor in accordance with principles described herein. Similar to implementation 100 described above, implementation 500 shows the core 102 (e.g., one core of a multi-core processor) that sends messages to the cache 104 (e.g., an L2 cache shared by multiple cores, only one of which is shown in FIG. 1) by way of the network 106. The data path 108 from core 102 to cache 104 may proceed via a plurality of nodes, not explicitly shown in FIG. 1. Each node that is part of network 106 may perform similar functions with respect to messages being sent (e.g., including waiting a fixed number N of clock cycles after receiving a speculative message and, if a corresponding override message is generated or received in that time, dispatching the override message to the next node with the same synchronized spacing of N cycles behind the speculative message). As such, the cores of the processor (including core 102 in this example) are referred to as source nodes of network 106 (since these nodes are the source of messages being sent), while other nodes of the network (not individually shown in FIG. 1) are referred to herein as transmission nodes (since these are responsible for forwarding and transmitting messages through the network) or endpoint nodes (the end destination for the messages, or cache 104 in this example).

A particular memory transaction 110 is shown to be transmitted from core 102 to cache 104 over network 106 and via data path 108. As described above, such a memory transaction may, in a conventional processor, be fully validated within the core, prior to being sent. A fully-validated message 112-FV (‘FV’ for Fully Validated) is depicted above implementation 500 as an example. As shown, fully-validated message 112-FV includes a validated physical address as well as validated parameters for the memory transaction. It will be understood that additional parameters, metadata, and other information not shown may be included in the message, though only those fields most relevant to the discussion at hand are explicitly illustrated.

Due to the full validation of fully-validated message 112-FV, there would be no risk associated with cache 104 performing fully-validated message 112-FV in accordance with the validated address and parameters as soon as the message is received. However, as has been described, there is also a cost to fully validating transaction messages such as message 112-FV, as it may take several clock cycles to complete all the validation tasks, and the message is not dispatched until that validation is complete.

For example, core 102 may receive a virtual address (e.g., embedded in an instruction, stored in a register, etc.) and take one or more cycles translating that virtual address into the corresponding physical address the cache 104 will need to perform the memory transaction. Once the physical address is determined, core 102 may proceed to determine parameters such as what type of memory the physical address corresponds to (e.g., normal memory, a particular memory-mapped device, etc.), what the security limitations are for that memory address, and so forth. These steps may take one or more additional clock cycles to perform. Additionally, core 102 may provide the address to its own internal L1 cache to determine if the data is already available more locally (e.g., an L1 cache hit, which could require a snoop action or obviate the need to for the data to be obtained from shared cache 104) and/or if any cache management is needed with respect to this address (e.g., a snoop such as described above, etc.). This, too, may consume one or more clock cycles that are performed prior to fully-validated message 112-FV being dispatched from core 102. Ultimately, it may take a number M of clock cycles for core 102 to construct and fully validate fully-validated message 112-FV, where M may equal some integer from approximately 2 to approximately 16. This may be inefficient and result in lower performance than if the message could be dispatched sooner.

As mentioned above, N of the M cycles that core 102 uses to construct and validate fully-validated message 112-FV may be associated with tasks that can be accurately speculated more quickly than explicitly validated. For example, if most or all of the access type, memory type, or security indicator parameters for memory transactions performed in service of a particular application have so far been the same, it may still take one or more clock cycles to validate (e.g., determine for sure) that a new memory transaction associated with this application will continue to follow the pattern, but it may at least be very likely that the previously-used parameters for the next memory transaction will be the same as most or all the others before it.

Accordingly, instead of a fully-validated message such as message 112-FV, FIG. 5 further shows that memory transaction 110 could be carried out using other messages (or combinations of messages) shown underneath implementation 500 in FIG. 1. As a first example, a speculative message 112-S1 (‘S’ for speculative) and an override message 114 could, in combination (as illustrated by the bracket incorporating both messages), be sent out as an alternative to a fully-validated message such as message 112-FV. As shown in this example, speculative message 112-S1 may include a message identifier (to allow it to be correlated with override message 114), a validated physical address similar to the address in fully-validated message 112-FV, and one or more speculative parameters (in contrast with the validated parameters of fully-validated message 112-FV). While not explicitly shown, it will be understood that certain validated parameters could also be included, but at least one parameter or aspect of speculative message 112-S1 will be understood to be speculative (e.g., a predicted or most probable value) rather than explicitly validated. The advantage of including speculative information in the speculative message is that speculative message 112-S1 may be dispatched for transmission earlier than a message such as fully-validated message 112-FV. For example, speculative message 112-S1 may be dispatched the fixed number N (e.g., an integer less than M) of clock cycles prior to when it would have been dispatched if it had been fully validated.

In the example of speculative message 112-S1, core 102 may discover N cycles after dispatching speculative message 112-S1 that the message is to be modified in some way (e.g., due to at least one of the speculative parameters being inaccurate). This situation may be relatively infrequent in many implementations, as the speculative parameters may be those for which very accurate predictions and speculations may be made (e.g., the examples mentioned above). When it occurs, however, implementation 500 shows that override message 114 may be sent after speculative message 112-S1 to allow for the inaccurate parameters to be modified. Override message 114 is shown to include a message identifier (e.g., the same message identifier as speculative message 112-S1 or some other identifier allowing override message 114 to be correlated to speculative message 112-S1 rather than to other messages that may be on network 106), as well as to include validated parameters configured to correct any inaccuracies of the speculative parameters the validation process uncovered after speculative message 112-S1 was dispatched. As has been described, the temporal relationship between the paired messages may be synchronized both by the source node of core 102 and by each transmission node in network 106 so that override message 114 is dispatched from each node exactly the fixed number N of clock cycles for that particular implementation. Accordingly, FIG. 1 indicates that override message 114 is dispatched “N cycles after 112-S1.”

Another (more frequent) possibility is that the speculative parameters of the speculative message are validated after the speculative message is dispatched and turn out to be accurate, such that no override message is needed. A speculative message 112-S2 is shown to illustrate this scenario may therefore include the same fields as speculative message 112-S1 (i.e., a message identifier, a validated physical address, and one or more speculative parameters, as well as, possibly, other data not shown due to being outside the scope of the present discussion). However, once the speculative parameters of speculative message 112-S2 are validated as being correct, the source node (core 102) in this example has no need to correct the speculative parameters with validated parameters. Accordingly, as illustrated by a dotted tag that reads “No Override Message,” core 102 may abstain from sending any override message and this abstention (i.e., the absence of an override message after N clock cycles have passed) will be interpreted by downstream nodes (including the endpoint cache) as an indication that the speculative parameters of speculative message 112-S2 are reliable and have been validated (e.g., verified to be accurate).

Implementation 500 may be implemented by components of a processor (e.g., a CPU) such as a core (e.g., core 102) configured to process instructions; a cache (e.g., cache 104) configured to cache data for the core (e.g., accelerate data access for the core with respect to a main memory and one or more memory-mapped devices); and a network (e.g., network 106) connecting the core and the cache. As has been mentioned, the network in an implementation such as implementation 500 may comprise a plurality of nodes. For example, the network may include a first node (e.g., a transmission node) configured to: 1) receive a speculative message (e.g., speculative message 112-S1) from a second node of the plurality of nodes (e.g., an upstream transmission node, a source node such as core 102 or another core, etc.); 2) receive, within a fixed number N of clock cycles after receiving the speculative message, an override message (e.g., override message 114) from the second node, the override message including a message identifier indicating a correspondence of the override message with the speculative message; 3) dispatch, during a first clock cycle, the speculative message to a third node of the plurality of nodes (e.g., a downstream transmission node, the endpoint node of cache 104, etc.); and 4) dispatch, based on the message identifier indicating the correspondence and during a second clock cycle that follows the first clock cycle by the fixed number N of clock cycles, the override message to the third node.

The example processor with these components may further include one or more additional cores (e.g., a multi-core CPU) that are likewise configured to process instructions. As such, the cache may be further configured to cache data for the additional cores (e.g., accelerate data access for the additional cores with respect to the main memory and the one or more memory-mapped devices), and the network may further connect the additional cores to the cache. In this example, messages from multiple cores may have different characteristics, and may affect one another as they travel through the network. For example, one core may produce messages for a first memory transaction where the speculation turns out to be inaccurate (e.g., speculative message 112-S1 and override message 114) while an additional core may produce a message for a second memory transaction there the speculation turns out to be accurate (e.g., speculative message 112-S2, for which no override message needed to be sent).

In this example, the first core may thus be configured to: 1) determine, for a first memory transaction to be performed by the cache, a first validated physical address and a first speculative parameter; 2) dispatch, during a third clock cycle prior to the first clock cycle, the speculative message with the first validated physical address and the first speculative parameter; 3) determine, after the third clock cycle, a first validated parameter configured to correct an inaccuracy of the first speculative parameter; and 4) dispatch, during a fourth clock cycle that is the fixed number N of clock cycles after the third clock cycle, the override message with the message identifier and the first validated parameter. Meanwhile, the additional core may be configured to: 1) determine, for a second memory transaction to be performed by the cache, a second validated physical address and a second speculative parameter; 2) dispatch an additional speculative message with the second validated physical address and the second speculative parameter; 3) validate, after dispatching the additional speculative message, that the second speculative parameter was accurate for the second memory transaction; and 4) based on the validation that the second speculative parameter was accurate for the second memory transaction, abstain from dispatching any override message corresponding with the additional speculative message.

Moreover, each of the transmission nodes in this example may be configured to behave similarly to the first node described above as messages are passed through the network and the synchronized coupling of corresponding speculative and override messages are maintained. For example, the third node of the plurality of nodes mentioned above may be configured to: 1) receive the speculative message from the first node of the network; 2) receive, within the fixed number N of clock cycles after receiving the speculative message, the override message from the first node; 3) dispatch the speculative message from the third node to a fourth node of the plurality of nodes; and 4) dispatch, based on the message identifier indicating the correspondence and during a clock cycle that is the fixed number N of clock cycles after dispatching the speculative message, the override message from the third node to the fourth node.

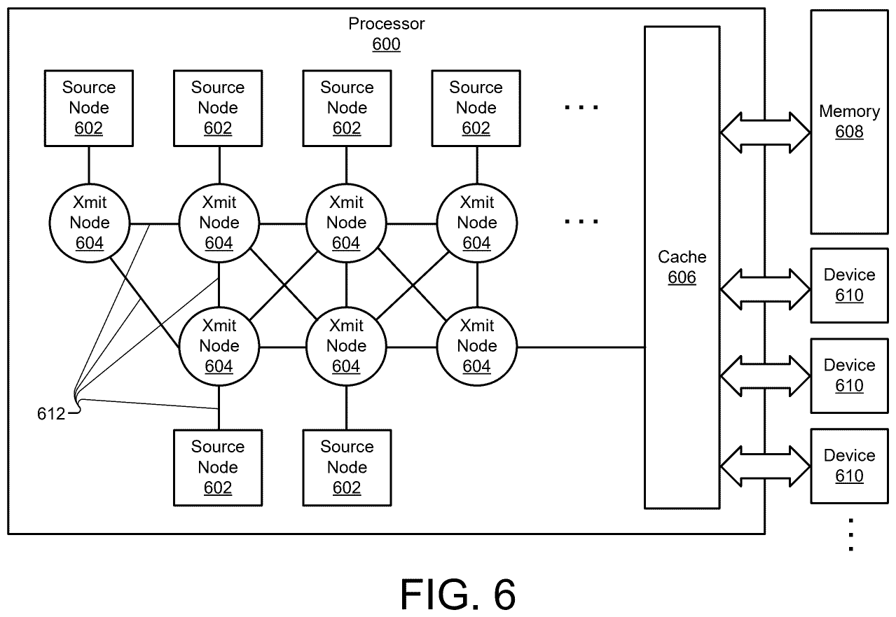

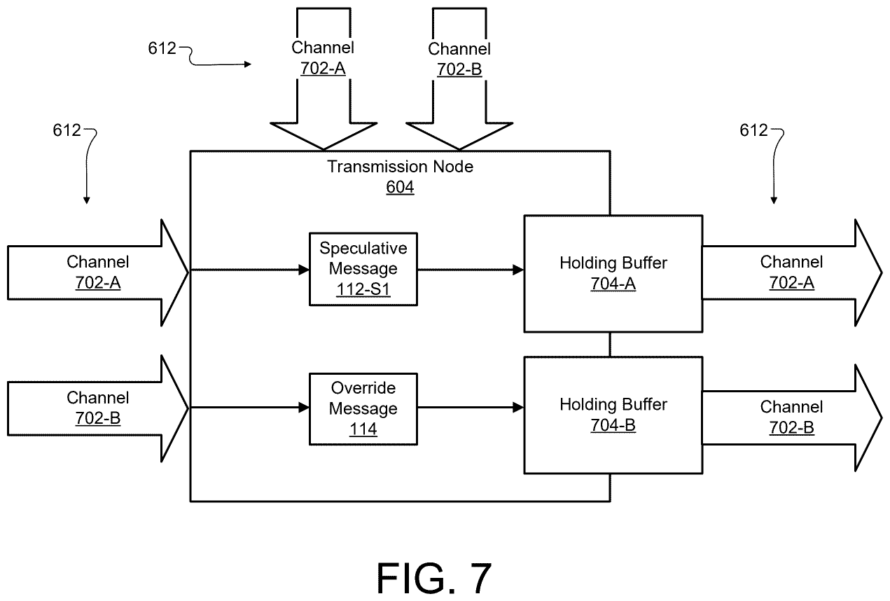

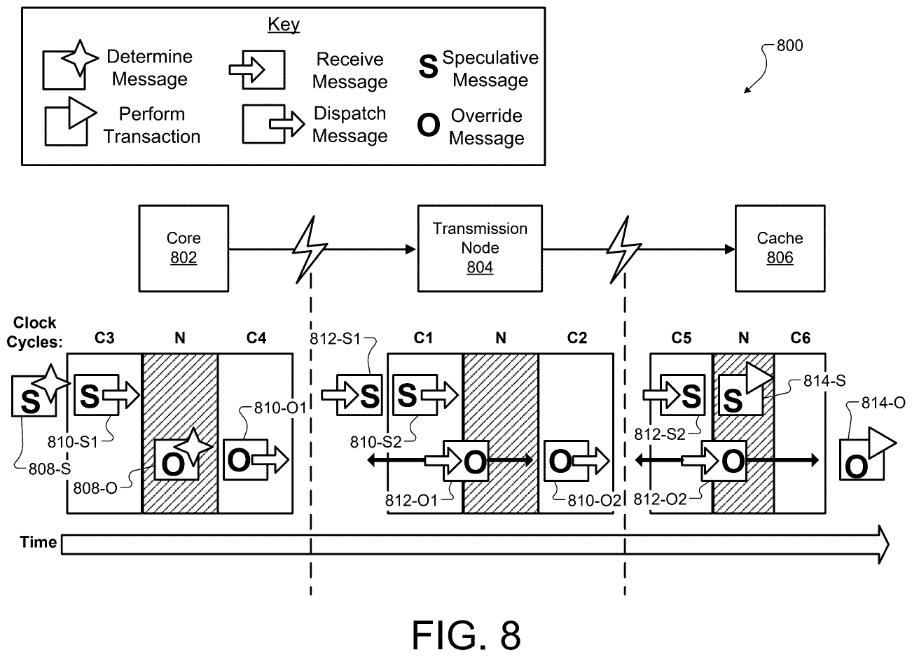

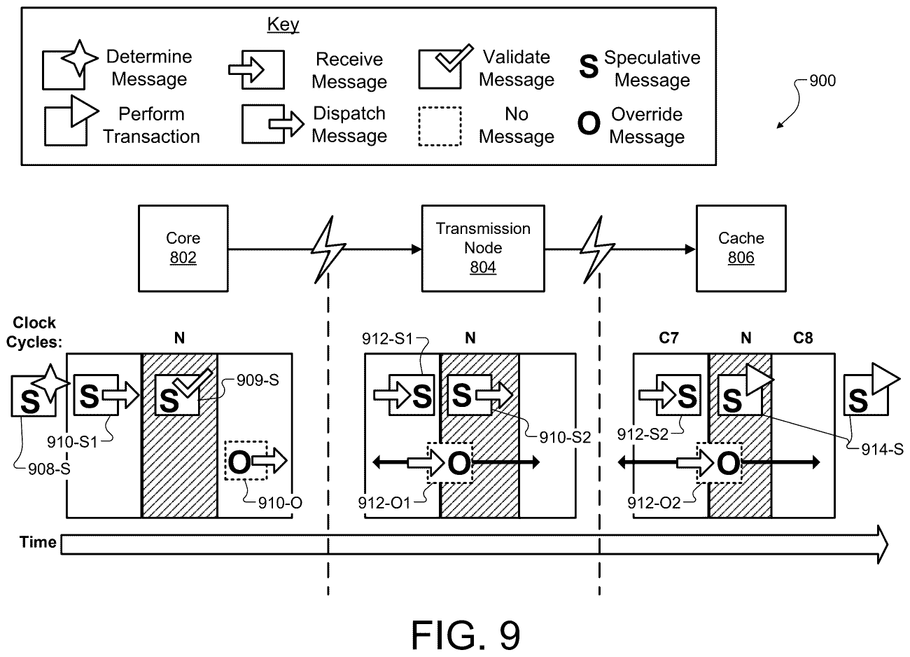

Various aspects of a processor configured to implement these components and to perform these operations will now be illustrated and described in relation to FIGS. 6-9. More particularly, as will be described, FIG. 6 shows certain aspects of an illustrative processor itself, including the components (e.g., source nodes or cores, transmission nodes, endpoint node or cache, memory and devices communicatively coupled to the cache, etc.) that have been described. FIG. 7 shows certain aspects of an illustrative transmission node and the multi-channel communication that may be implemented between it and other nodes of the network. FIGS. 8 and 9 then show example message transmissions in which a speculative message with speculative parameters is modified by an override message (FIG. 8) and in which a speculative message with speculative parameters is validated such that no override message is needed (FIG. 9). In the following description (and in FIGS. 8 and 9, in particular), certain ordinal numbers (e.g., first, second, third, etc.) used in the preceding paragraphs to describe various nodes and clock cycles will be reflected in the numbering of the elements in the figures.

FIG. 6 shows certain aspects of an illustrative processor 600 that includes a network connecting a cache to a plurality of cores (and/or other source nodes) in accordance with principles described herein. As shown, the network of processor 600 includes a plurality of source nodes 602 (e.g., implemented as processor cores such as core 102 or other suitable components capable of originating and sending messages via the network), a plurality of transmission nodes 604 (each labeled as an “Xmit Node 604”), and a cache 606 that serves as the endpoint node of the network. Cache 606 is shown to not only connect to the network of source and transmission nodes, but also to interface with a memory 608 (e.g., representing main memory) and several devices 610 (e.g., representing memory-mapped input/output devices such as any of the devices described above). Cache 606 may implement memory transactions with respect to memory 608 and several devices 610 based on the information it receives in memory transaction messages from source nodes 602 over the network.

In the example of FIG. 6, the transmission nodes 604 are shown in a mesh topology in which each source node 602 connects to one transmission node 604 and each transmission node 604 then connects to at least two others. In this example, a single transmission node 604 connects the endpoint node of cache 606 to the rest of the network, though it will be understood that multiple transmission nodes 604 could be communicatively coupled to cache 606 in other implementations. As has been mentioned, the network topology shown in FIG. 6 is illustrated as but one example, though any of various topologies (e.g., point-to-point, start, tree, mesh, hybrid, etc.) could be utilized for the network as may serve a particular implementation. In the example of FIG. 6, seven transmission nodes are shown, such that messages dispatched by any source node would likely reach cache 606 on a data path with approximately 2-4 transmission nodes 604. It will be understood that, in other examples, different numbers of nodes may be used to create paths with different numbers of stops (e.g., between one and about twelve stops in certain examples).

In the examples described above and illustrated in more detail below (e.g., in relation to FIGS. 8-9) a first node is described as a transmission node that receives speculative messages and, after N clock cycles, receives corresponding override messages (if such were produced). In the notation used in examples herein, this first node receives the messages from a second node (e.g., an upstream node) and then dispatches the messages (with the same synchronized timing between speculative and override messages) to a third node (e.g., a downstream node). While the first node is described as one of transmission nodes 604 in each of these examples, the second and third nodes may be implemented in different ways depending on the circumstances. For instance, the second node may be implemented by a core of the processor (i.e., the second node may be a source node) or by a second transmission node (i.e., the second node may be a transmission node 604 connected to the first transmission node).

Additionally, certain examples described herein relate to messages for at least two memory transactions that pass through the first node (e.g., a first memory transaction that is later assigned an override message when full validation of the speculative parameters reveals a modification, and a second memory transaction that needs no such message since the full validation confirms the speculative parameters included in the speculative message). In these examples, it will be understood that, if messages associated with the first memory transaction are received at the first node from the second node, the second speculative message may be received either from that same second node (where, again, that second node may be implemented by either a core of the processor or a different transmission node) or from a fourth node of the network (i.e., a node separate from the second node that sends the first messages and separate from the third node to which the messages are forwarded). As with the second node, the fourth node may be implemented by an additional core of the processor or by a transmission node.

In other words, different types of messages moving through the network (speculative messages with and without override messages trailing N cycles behind them) may originate at a variety of source nodes 602 and take a variety of routes through the network as conditions permit. An override message will follow a same data path (i.e., originating at the same source node and traversing the same transmission nodes to ultimately arrive at the same endpoint node) as its corresponding speculative message, albeit possibly traveling by way of a different communication channel, as will be described in more detail below. In some cases (e.g., certain network topologies, etc.), it may be guaranteed that coupled speculative and override messages will be sent to the same subsequent node since all messages coming into a particular node could be sent to the same subsequent node (i.e., there is only one choice of subsequent node). In other cases, a particular transmission node could have multiple choices of subsequent nodes to which it could forward messages, such that the node may perform some coordination (e.g., based on the message identifier within the override message, which indicates the correspondence of the override message with the speculative message) to ensure that every override message is dispatched to the same subsequent node as the corresponding speculative message was sent. While these mechanisms may ensure that coupled speculative and override messages follow the same paths, network conditions may cause different coupled messages to traverse complex data paths with irregular timing (due to delays of different lengths from unpredictable network traffic) and/or other challenges that make it difficult to guarantee that an override message will remain properly coupled (e.g., within the fixed number N of clock cycles) to its corresponding speculative message as both make their way through the traffic of the network. To address this challenge, each transmission node 604 in the network may be specifically configured to support the coupled message transmission (i.e., the N-cycle synchronization between the messages) as the nodes process incoming messages and pass them along to the next node.

To illustrate certain ways that such challenges may be introduced and addressed by a processor such as processor 600, connections 612 in FIG. 6 are shown in more detail with a particular transmission node 604 in FIG. 7. More particularly, FIG. 7 shows certain aspects of an illustrative transmission node 604 and multi-channel communication between this transmission node and other nodes of the network in accordance with principles described herein.

As shown in FIG. 7, this transmission node 604 may receive a speculative message (e.g., the speculative message 112-S1 described in relation to FIG. 1) and an override message (e.g., the override message 114 described above). As shown, each connection 612 in the network may be implemented, in this example, as a multi-channel connection that includes at least a first channel 702-A and a second channel 702-B. As further shown (and as was more fully illustrated above in FIG. 6), a given transmission node 604 may have more than one connections 612 whereby messages may be received and/or transmitted. For instance, the transmission node 604 in FIG. 7 is shown to include two connections 612 (to upstream nodes) whereby messages may be received in addition to one connection 612 (to a downstream node) whereby messages may be sent.

The communication channels 702-A and 702-B may be similar to one another in certain examples (e.g., including a similar bandwidth or carrying capacity, etc.). In other examples, however, the channels may have significant differences to provide certain features that help configure the channels to carry different types of messages and efficiently implement coupled message transmission described herein. For example, one channel (e.g., first channel 702-A) may be configured to support a relatively large amount of data. As such, speculative message 112-S1 may be received and dispatched on this first channel along with the relatively large number of other speculative messages flowing through the network. Another channel (e.g., second channel 702-B) may then be configured to support a smaller amount of data. As such, override message 114 may be received and dispatched on the second channel with the relatively few other override messages that are being transmitted through the network.

As shown, first channel 702-A may be separate from second channel 702-B of the network and these both may be used in a manner that allows the processor to have a greater degree of control over override messages on second channel 702-B than it has over speculative messages on first channel 702-A. For example, the number of messages in channel 702-B may be a subset of the messages in channel 702-A, such that any delays experienced on a channel 702-B data path will be experienced to at least the same degree (if not to a greater degree) on a corresponding channel 702-A data path. In other words, second channel 702-B may be guaranteed to have no more messages to transmit than first channel 702-A. As both channels may transmit one buffered message per clock cycle, the fact that there are guaranteed to be fewer messages to transmit over the second channel than the first channel means that there is never a situation that override messages (traveling via second channel 702-B) will experience a delay that is not at least equally experienced by their corresponding speculative messages (traveling via first channel 702-A).

Because of the variability in traffic flow and the fact that messages may be received from multiple connections on the same clock cycle, however, it may not be guaranteed that any particular message will move through the transmission node 604 at any particular rate. For example, speculative message 112-S1 may be received during one clock cycle and sent out the next clock cycle, or it could be received one clock cycle and then be held for many clock cycles (e.g., behind other messages that are queued to use the output connection 612) before being transmitted to the next node. To manage such delays, transmission node 604 is shown to include separate holding buffers for each of the two channels. Specifically, a holding buffer 704-A is shown to be associated with channel 702-A, while a holding buffer 704-B is shown to be associated with channel 702-B.

As used herein, a node of the network (e.g., a source node, a transmission node, etc.) may “dispatch” a message by putting the message in a holding buffer where it may wait zero or more clock cycles to then actually be communicated over the channel (i.e., transmitted to the next node). Thus, in some examples, dispatching a message may be synonymous with transmitting or sending the message (as there is no delay or an equivalent delay for messages sent on both channels), while, in other examples, dispatching a message may be a somewhat separate concept than the actual message transmission to the next node, since, after being dispatched to the holding buffer, the message may be held for several cycles in the holding buffer to wait for its turn on the communication channel.

While the messages may generally be dispatched and transmitted in the same order they are received, the different amount of traffic on channel 702-A and channel 702-B may tend to introduce uncertainty in the synchronization between a speculative message and an override message. For example, if a speculative message that has a corresponding override message is received after ten other speculative messages that have no corresponding override messages associated therewith, this eleventh speculative message may be held in holding buffer 704-A for a fair amount of time after being dispatched, while the override message may be free to move to the next node immediately after being dispatched to holding buffer 704-B.

However, if the messages are dispatched with the fixed number N of clock cycles delay between them (whenever they may have been received), it can be guaranteed that the override message will be received at the next node no later than N clock cycles after the speculative message, though, in certain cases, it could arrive sooner than that. For example, if there is no traffic on the network and transmission node 604 properly dispatches override message 114 to holding buffer 704-B exactly N cycles after dispatching speculative message 112-S1 to holding buffer 704-A, override message 114 may arrive to the next node exactly N cycles after speculative message 112-S1 arrives, and the synchronized coupling of N cycles between them may be maintained. If, on the other hand, there is traffic on the network that includes several speculative messages that are not coupled with corresponding override messages (as in the example above), the messages could be dispatched with this same relationship (i.e., N cycles apart), yet the override message could actually be transmitted from holding buffer 704-B (and received at the next node) sooner than N cycles after speculative message 112-S1 is transmitted/received. For example, the override message could be transmitted/received the same cycle as speculative message 112-S1 is transmitted/received, or even before speculative message 112-S1 is transmitted/received. Since channel 702-B is only responsible for communicating a subset of the messages channel 702-A communicates, however, dispatching coupled messages N cycles apart allows it to be guaranteed that each override message will be transmitted/received no later than N cycles after the corresponding speculative message is transmitted/received.

As mentioned above, message identifiers may be included on each message to help correlate the messages when the override messages get ahead of their respective speculative messages in this way. For example, each of the messages may include sufficient information to identify the correspondences between them, since an override message that is received may correspond to a speculative message that is already dispatched, just about to be dispatched, or has not even yet been received at the node.

In a particular example, there may be at least a one cycle delay in the transmission of speculative message 112-S1 after it is dispatched. In other words, the dispatching of speculative message 112-S1 may include releasing speculative message 112-S1 to first holding buffer 704-A on one clock cycle, then, instead of transmitting the speculative message on the next clock cycle, the first holding buffer may hold the speculative message for one or more additional cycles before transmitting it (e.g., thereby creating a delay). In this example, override message 114, which may be dispatched N cycles after the first clock cycle (on the second clock cycle), may experience less of a delay, such that it will be transmitted and received less than N cycles after the speculative message. In other words, the dispatching of override message 114 may include releasing override message 114 to second holding buffer 704-B, which may hold override message 114 for fewer clock cycles than first holding buffer 704-A holds speculative message 112-S1 (e.g., transmitting override message 114 without delay or at least with a shorter delay than speculative message 112-S1 had). In this way, override message 114 would arrive at the third node of the network less than the fixed number N of clock cycles after speculative message 112-S1. Indeed, if there is sufficient difference in the respective delays of the speculative message in first holding buffer 704-A and the override message in second holding buffer 704-B, override message 114 could arrive at the third node even before the speculative message 112-S1 arrives. In any of these examples, it is fine for the override message to arrive early as long as it has arrived within the N cycles after the speculative message (which is guaranteed for the reasons described above) and as long as, at each node, it is dispatched with this same N-cycle synchronization after the corresponding speculative message.

Principles have now been described relating to coupled message transmission that allows a fixed timing relationship between messages to be maintained as coupled messages (i.e., a speculative message and an override message associated with the same memory transaction) move through a complex network, thus making it safe to send speculative memory transactions prior to full validation being performed and the benefits associated therewith. To illustrate more concrete examples of the timing, FIGS. 8 and 9 will now be described. FIG. 8 shows certain aspects of an illustrative message transmission 800 in which a speculative message with speculative parameters (e.g., the speculative message 112-S1 described above) is corrected by an override message coupled with the speculative message in the transmission. FIG. 9 then shows certain aspects of an illustrative message transmission 900 in which a speculative message with speculative parameters (e.g., the speculative message 112-S2 described above) is validated such that no override message is needed for the transmission.

In both of these examples, a timeline from left to right shows movement of a memory transaction from a core 802 to a transmission node 804, to a cache 806. Small omission marks (lightning bolts) on either side of transmission node 804 are included in both figures to indicate that additional transmission nodes may also be included along the data path between core 802 and cache 806. It will be understood that similar operations as are described in relation to transmission node 804 may be performed at any additional transmission nodes along the path.

Respective Keys are shown in FIGS. 8 and 9 to explicate symbols used for the respective message transmissions being illustrated. Specifically, symbols in the Key of FIG. 8 are shown to indicate: messages being determined or generated (“Determine Message”), transactions being performed based on the messages (“Perform Transaction”), messages being received (“Receive Message”), and messages being dispatched to the holding buffer (though not necessarily transmitted, as described above) (“Dispatch Message”). The same symbols are also shown in the Key of FIG. 9, as well as additional symbols to indicate speculative parameters being fully validated after being dispatched early (“Validate Messages”), and override messages that are not needed and therefore not sent or received to avoid clogging up the network (“No Message”). Further shown in both Keys, a “S” on any of these symbols indicates that the symbol relates to a speculative message, while an “O” on a symbol indicates that the symbol relates to an override message.

In FIGS. 8 and 9, certain clock cycles are labeled above the time slots in which the actions are performed or completed, as will be described in more detail below. The numbering of the clock cycles (e.g., “C1”, “C2”, “C3”, etc.) is arbitrary, but may align with the numbering of clock cycles elsewhere in this disclosure and in the claims set forth below. The shaded time slots labeled “N” will be understood to represent a fixed number N of clock cycles (e.g., 2 clock cycles, 3 clock cycles, 5 clock cycles, etc.). Other time slots (e.g., labeled “C1”, “C2”, etc.) will be understood to represent single clock cycles, while space between specific time slots in the figures may represent any number of clock cycles (e.g., as the message passes through other transmission nodes, etc.). Based on these notational aspects, each of message transmissions 800 and 900 will now be described in more detail.

Beginning with transmission node 804 in FIG. 8, a receive symbol 812-S1 shows that transmission node 804 may receive a speculative message from a second node of the network (e.g., an upstream transmission node or a source node implemented by core 802).

A receive symbol 812-O1 also shows that transmission node 804 may receive an override message from the second node. As has been described, the override message may include a message identifier indicating a correspondence of the override message with the speculative message. As indicated by arrows connected to symbol 812-O1 and the placement of symbol 812-O1 between clock cycle C1 and the N clock cycles following C1, it will be understood that the override message may be received at the first node within the fixed number N of clock cycles after receiving the speculative message (i.e., no later than N cycles after the speculative message is received). For example, for the reasons described above, the override message could be received before the speculative message, on the same clock cycle as the speculative message, or up to N cycles after the speculative message.

A dispatch symbol 810-S2 shows that transmission node 804 may dispatch the speculative message during a first clock cycle C1 sometime after the speculative message is received. For example, the speculative message may be dispatched from the first node (transmission node 804) to a third node of the network (e.g., a downstream transmission node or an endpoint node implemented by cache 806).

A dispatch symbol 810-O2 then shows that transmission node 804 may dispatch, based on the message identifier indicating the correspondence, the override message from the first node to the third node. Specifically, this dispatching of the override message is shown to be performed during a second clock cycle C2 that follows the first clock cycle C1 by the fixed number N of clock cycles. While there is some imprecision about when the override message was received, FIG. 8 shows no similar imprecision for the override message being dispatched after the N clock cycles.

Turning to core 802 in FIG. 8, a determine symbol 808-S shows that core 802 may be configured to determine (e.g., generate, partially validate, etc.) the speculative message for this first memory transaction to be performed by cache 806. For example, at this time (prior to a third clock cycle C3), core 802 may determine a first validated physical address and one or more first speculative parameters. The first speculative parameters may include any of the speculative parameters that have been described herein. For example, the first speculative parameter may include a speculative memory type for the first memory transaction. Additionally or alternatively, the first speculative parameter may include a speculative security indicator for the first memory transaction or any other parameter for the transaction as may serve a particular implementation.

A dispatch symbol 810-S1 shows that core 802 may then be configured to dispatch this speculative message with the first validated physical address and the first speculative parameter. More particularly, as shown, core 802 may dispatch the speculative message during the third clock cycle C3 (which is prior to first clock cycle C1).

Another determine symbol 808-O shows that, after dispatching the speculative message during the third clock cycle C3, core 802 may determine a first validated parameter configured to correct an inaccuracy of the first speculative parameter. In other words, as additional validation is performed for speculative parameters that were dispatched at clock cycle C3, validated parameters that are different from the speculative parameters that were sent out may be determined and an override message may be generated. For example, the first validated parameter may include a validated memory type for the first memory transaction and/or a validated security indicator for the first memory transaction. These validated parameters would correspond to (and be configured to correct inaccuracies of) the speculative parameters mentioned above.

A dispatch symbol 810-O1 shows that core 802 may then dispatch the override message with the message identifier and the first validated parameter. As shown, the override message may be dispatched during a fourth clock cycle C4 that is the fixed number N of clock cycles after the third clock cycle C3. While clock cycle C4 is shown to be prior to first clock cycle C1 in this example, it will be understood that, in certain examples, clock cycle C4 could be coincident with clock cycle C1 or could even follow shortly after clock cycle C1.

Turning to cache 806 in FIG. 8, a receive symbol 812-S2 shows that cache 806 may receive the speculative message with the first validated physical address and the first speculative parameter. For example, the speculative message may be received from transmission node 804 or from another intermediary node between transmission node 804 and cache 806. As shown, the speculative message may be received during a fifth clock cycle C5. This clock cycle is shown to be some time after the second clock cycle C2 in which the override message was dispatched, though it will be understood that clock cycle C5 could be earlier, such as coincident with clock cycle C2 or even shortly before clock cycle C2 (as long as it follows clock cycle C1).

A perform symbol 814-S shows that cache 806 may begin performing the first memory transaction based on the speculative message (e.g., including the speculative parameters). In other words, though the speculative parameters might include inaccuracies (and in this case, they do, as the cache will soon be informed), cache 806 gets a head start on performing the memory transaction using the speculative message.

A receive symbol 812-O2 shows that cache 806 may receive the override message no later than a sixth clock cycle that follows the fifth clock cycle by the fixed number N of clock cycles. Similarly as described above, the different channel delays in the network could cause the override message to be received prior to, coincident with, or shortly after the speculative message is received (symbol 812-S2), but in no event will the override message be received after the sixth clock cycle C6.

Accordingly, based on the speculative message, the override message, and the message identifier indicating the correspondence, a perform symbol 814-O shows that cache 806 may continue performing the first memory transaction using the first validated parameter instead of the first speculative parameter. In other words, cache 806 may take actions to correct work that has been done, if any, based on the inaccuracies of the speculative parameters in the speculative message and to ensure that the memory transaction is performed properly. In this scenario, there may therefore be little or no performance improvement based on the coupled message transmission since the speculative memory transaction is needing to be modified. While there may still be a performance improvement in certain cases, there could even be a slight penalty in other cases. It will be recalled, however, that this scenario may occur much less frequently than the scenario where no correction is needed (illustrated in FIG. 9 below) and that this ability to correct inaccurate speculative parameters allows for that more common scenario where the notable performance improvement is consistently enjoyed.

Message transmission 900 of FIG. 9 will now be described. The speculative message described above in relation to FIG. 8 (which had inaccurate speculative parameters and therefore needed an override message) will be referred to in the following description as the first speculative message to differentiate it from a second speculative message (which has accurate speculative parameters and therefore no need of an override message) that is the focus of message transmission 900.

Beginning, again, with transmission node 804, a receive symbol 912-S1 shows that transmission node 804 may receive the second speculative message. A dispatch symbol 910-S2 then shows that transmission node 804 may dispatch this second speculative message from the first node (e.g., transmission node 804) to the third node (e.g., a downstream transmission node or the endpoint node of cache 806). Since the speculative parameters turned out to be accurate for this second speculative message (as mentioned above and as will be described in more detail below), a symbol 912-O1 shows that no override message corresponding to the second speculative message is ever received by transmission node 804. Naturally, since no override message is received, neither does transmission node 804 need to dispatch any override message in connection with the second speculative message, thereby helping avoid creating unnecessary network traffic.

Turning to core 802 in FIG. 9, a determine symbol 908-S shows that core 802 may be configured to determine (e.g., generate, partially validate, etc.) the second speculative message for this second memory transaction to be performed by cache 806. For example, as similarly described above in relation to FIG. 8, core 802 may determine a second validated physical address and one or more second speculative parameters (e.g., any of the speculative parameters that have been described herein).

Also similar to the first message transmission 800 above, a dispatch symbol 910-S1 shows that core 802 may then be configured to dispatch this speculative message with the second validated physical address and the second one or more speculative parameters.

However, unlike the scenario described with the first memory transaction in FIG. 8, a validate symbol 909-S shows that core 802 may validate, after dispatching the second speculative message, that the second speculative parameter was accurate for the second memory transaction. As a result, and in contrast with the example of FIG. 8, no override message with a validated parameter will need to be generated and dispatched to correct the speculative parameters (i.e., since the speculation, in this case, was verified to be accurate).

A symbol 910-O therefore shows that, based on the validating that the second speculative parameter was accurate for the second memory transaction, core 802 abstains from dispatching any override message corresponding with the second speculative message.

Turning to cache 806 in FIG. 9, a symbol 912-S2 shows that cache 806 may receive the second speculative message with the second validated physical address and the second speculative parameter. For example, the second speculative message may be received from transmission node 804 or from another intermediary node between transmission node 804 and cache 806. As shown, the speculative message may be received during a seventh clock cycle C7. This clock cycle may be any time after the second speculative message was dispatched by transmission node 804.

A perform symbol 914-S shows that cache 806 may begin performing the second memory transaction based on the second speculative message (e.g., including the speculative parameters). In other words, though the speculative parameters might include inaccuracies (though in this case they do not, as the cache will soon infer), cache 806 gets a head start on performing the memory transaction using the second speculative message. More particularly, as shown by a symbol 912-O2, no override message corresponding to the second speculative message is received, since no such message had to be generated or dispatched in the first place. If such a message were coming, it would be guaranteed to arrive no later than an eighth clock cycle that follows the seventh clock cycle by the fixed number N of clock cycles. Accordingly, cache 806 may determine, during the eighth clock cycle, that no override message corresponding to the second speculative message has been received.

Another perform symbol 914-S following the eighth clock cycle shows that, based on the second speculative message and the determination that no override message corresponding to the second speculative message has been received, cache 806 may continue performing the second memory transaction. In contrast to the scenario described above in relation to FIG. 8, this second memory transaction illustrates a clear performance improvement to be provided by the coupled message transmission since the speculative memory transaction turned out to be accurate and cache 806 was able to begin working on the transaction N cycles earlier than it would have otherwise. As has been described, this scenario in which the speculative parameters are correct may occur more frequently (and, in some implementations, far more frequently) than the scenario where correction is performed. Accordingly the overall performance of the processor may be improved by coupling messages in accordance with principles described herein.

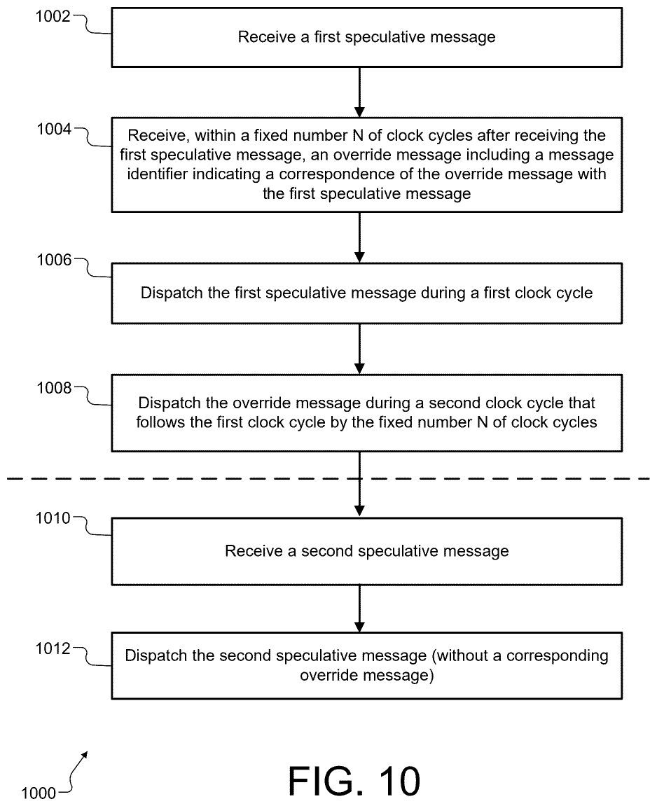

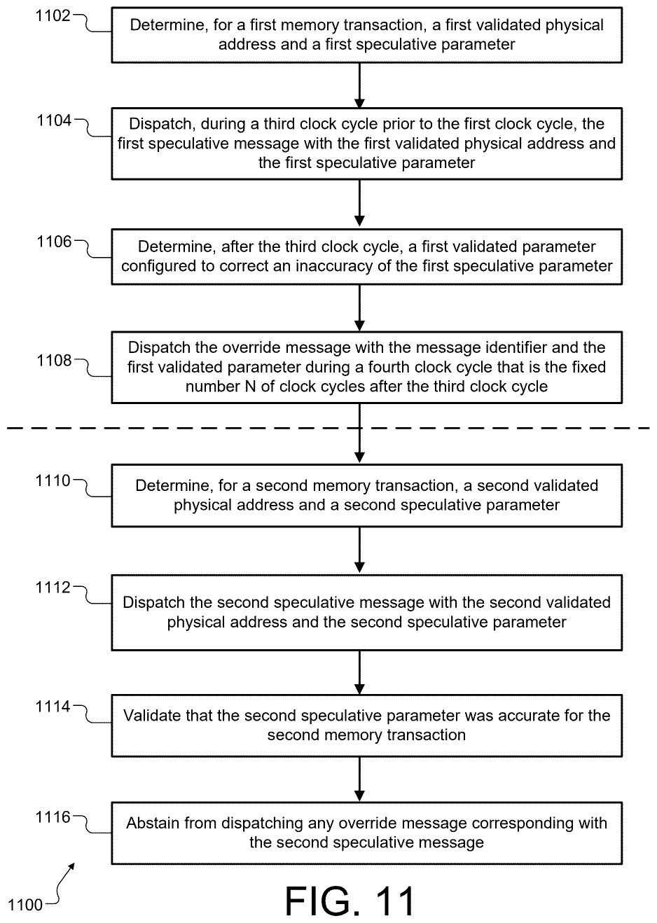

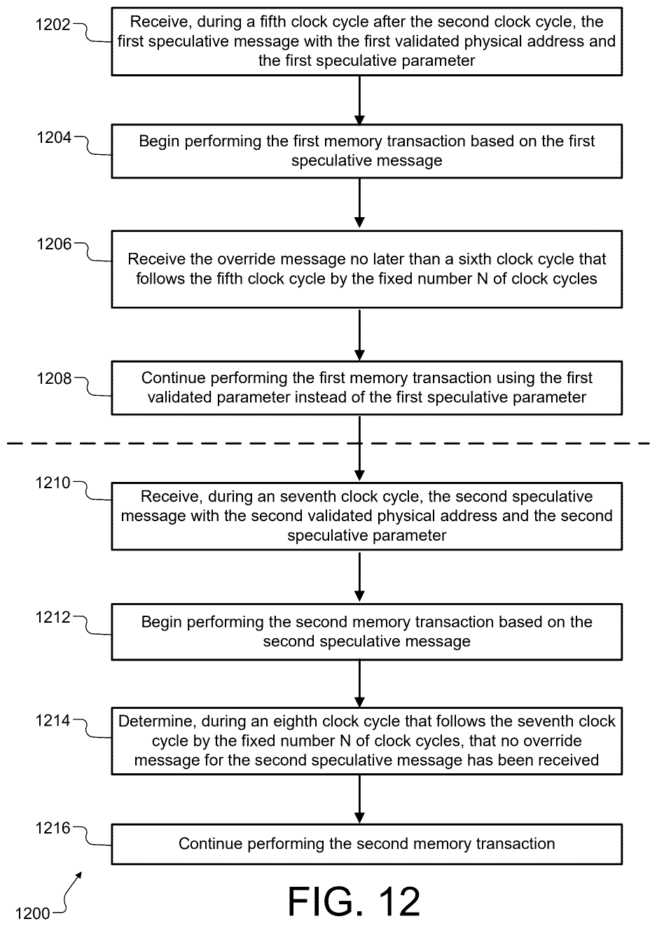

FIGS. 10-12 show illustrative methods for coupled message transmission to modify speculative memory transactions in a processor in accordance with principles described herein. More particularly, FIG. 10 shows a method 1000 that may be performed by a transmission node (e.g., transmission node 804 above), FIG. 11 shows a method 1100 that may be performed by a core or other source node (e.g., core 802 above), and FIG. 12 shows a method 1200 that may be performed by a cache (e.g., cache 806 above). As has been described, all of these components may be included within a processor (e.g., an implementation of processor 600). As such, the processor may be configured to perform all of these methods.

While FIGS. 10-12 show illustrative operations according to specific implementations, it will be understood that other implementations of these methods may omit, add to, reorder, and/or modify any of the operations that are explicitly represented in FIGS. 10-12. Additionally, while the operations of methods 1000, 1100, and 1200 are illustrated with arrows suggestive of a sequential order of operation, it will be understood that one or more of the operations of methods 1000, 1100, or 1200 may be performed concurrently (e.g., in parallel) with one another. In each of the methods, operations above a dashed line represent operations performed in relation to a speculative memory transaction that turns out to include inaccuracies (e.g., such as illustrated above in FIG. 8), while operations below the dashed line represent operations performed in relation to a different speculative memory transaction that validated as accurate (e.g., such as illustrated above in FIG. 9). Each of FIGS. 10-12 and the methods included therein will now be described in more detail.

In FIG. 10, operation 1002 is performed by the first node by receiving a first speculative message. For example, the first speculative message may be received at a first node of a network (e.g., a transmission node) from a second node of the network (e.g., an upstream transmission node or a source node such as a processor core). The network will be understood to represent any network described herein that connects a core and a cache of a processor. At operation 1004, the first node may receive, within a fixed number N of clock cycles after receiving the speculative message, an override message from the second node. For example, the override message may include a message identifier indicating a correspondence of the override message with the speculative message. At operation 1006, the first node may dispatch the speculative message from the first node to a third node of the network. For example, the speculative message may be dispatched during a first clock cycle (e.g., such that it will be transmitted the next clock cycle or at a later clock cycle depending on network traffic). At operation 1008, the first node may then dispatch the override message from the first node to the third node. For example, based on the message identifier indicating the correspondence with the first speculative message, the override message may be dispatched during a second clock cycle that follows the first clock cycle by the fixed number N of clock cycles. By dispatching the override message during the second cycle, it may be transmitted the next clock cycle or later, depending on network traffic. However, as has been described, it may be guaranteed to arrive at the third node no later than N clock cycles after the first speculative message arrives.

At operation 1010, the first node receives a second speculative message. For example, like the first speculative message, the second speculative message may have been generated using speculative parameters so that it could be dispatched before the time was taken to fully validate the parameters. However, unlike the first speculative message, it will be understood that the second speculative message was ultimately validated without identifying any inaccuracies (as will be described in more detail below in relation to FIG. 11). Accordingly, at operation 1012, the first node may dispatch the second speculative message from the first node to the third node. No override message corresponding to this second speculative message will be received or need to be dispatched by the first node, so no further action is required by the first node for the second memory transaction.

In FIG. 11, operation 1102 is performed by the core by determining, for a first memory transaction to be performed by a cache of the processor, a first validated physical address and a first speculative parameter. At operation 1104, the core dispatches the first speculative message with the first validated physical address and the first speculative parameter. For example, this dispatch of the first speculative message may be performed during a third clock cycle prior to the first clock cycle referred to in method 1000 above. At operation 1106, the core determines, after the third clock cycle, a first validated parameter configured to correct an inaccuracy of the first speculative parameter. Accordingly, at operation 1108, the core dispatches the override message with the message identifier and the first validated parameter. More particularly, the core dispatches this override message during a fourth clock cycle that is the fixed number N of clock cycles after the third clock cycle.

At operation 1110, the core determines a second validated physical address and a second speculative parameter for a second memory transaction to be performed by the cache of the processor. At operation 1112, the core then dispatches the second speculative message with the second validated physical address and the second speculative parameter. At operation 1114, after dispatching the second speculative message at operation 1112, the core validates that the second speculative parameter was accurate for the second memory transaction. Accordingly, based on the validating that the second speculative parameter was accurate for the second memory transaction, the core abstains, at operation 1116, from dispatching any override message corresponding with the second speculative message.

In FIG. 12, operation 1202 is performed by the cache by receiving the first speculative message with the first validated physical address and the first speculative parameter. For example, this first speculative message may be received during a fifth clock cycle sometime after the first speculative message transmitted the first speculative message. At operation 1204, the cache may begin performing the first memory transaction based on the first speculative message. At operation 1206, no later than a sixth clock cycle that follows the fifth clock cycle by the fixed number N of clock cycles, the cache may then receive the override message. Based on the first speculative message received at operation 1202, the override message received at operation 1206, and the message identifier (included in the override message to indicate the correspondence with the first speculative message), the cache may, at operation 1208, continue performing the first memory transaction. However, as the performance of the first memory transaction is continued, the cache may use the first validated parameter (from the override message) instead of the first speculative parameter (from the first speculative message). In other words, the first validated parameter may override the first speculative parameter, since there is, in this case, an inaccuracy in the first speculative parameter that is corrected in the first validated parameter.

At operation 1210, the cache receives the second speculative message with the second validated physical address and the second speculative parameter. For example, this second speculative message may be received during a seventh clock cycle sometime after the second speculative message was transmitted by the first node. At operation 1212, the cache may begin performing the second memory transaction based on the second speculative message. Because there is, in this case, no inaccuracy in the second speculative parameter that needs correction, at operation 1214, the cache may determine, during an eighth clock cycle that follows the seventh clock cycle by the fixed number N of clock cycles, that no override message corresponding to the second speculative message has been received. This determination is equivalent to determining that no override message will be received or was needed, since it would be guaranteed to arrive by the eighth clock cycle. Accordingly, the second speculative message can, by the eighth clock cycle, be assumed to be fully validated to be accurate. Based on the second speculative message and the determination that no override message corresponding to the second speculative message has been received, the cache may therefore, at operation 1216, continue performing the second memory transaction with no correction or modification being made.

As has been mentioned, various methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory.

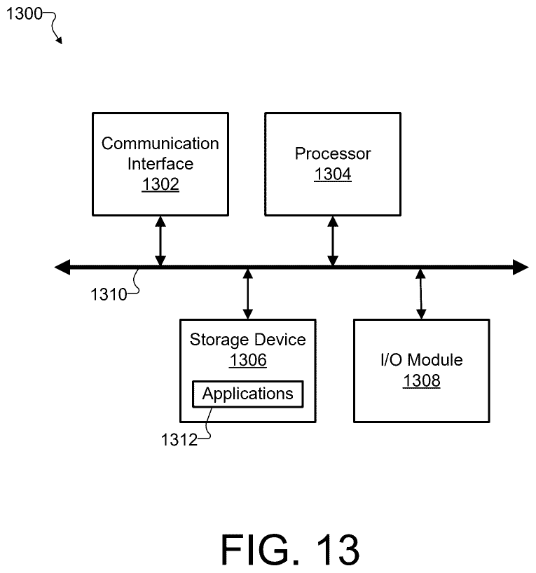

FIG. 13 shows an illustrative computing device 1300 that may use or implement one or more processors (e.g., CPUs, etc.) such as those described herein. As shown in FIG. 13, computing device 1300 may include a communication interface 1302, a processor 1304 (which may represent an implementation of processor 600 with various components such as processor cores, a cache, and a multi-node network connecting them), a storage device 1306, and an input/output (I/O) module 1308 communicatively connected via a communication infrastructure 1310. While an illustrative computing device 1300 is shown in FIG. 13, the components illustrated in FIG. 13 are not intended to be limiting. Additional or alternative components may be used in other embodiments. Components of computing device 1300 shown in FIG. 13 will now be described in additional detail.

Communication interface 1302 may be configured to communicate with one or more computing devices. Examples of communication interface 1302 include, without limitation, a wired network interface (such as a network interface card), a wireless network interface (such as a wireless network interface card), a modem, an audio/video connection, and any other suitable interface.

Processor 1304 generally represents any type or form of processing unit capable of processing data or interpreting, executing, and/or directing execution of one or more of the instructions, processes, and/or operations described herein. Processor 1304 may direct execution of operations in accordance with one or more applications 1312 or other computer-executable instructions such as may be stored in storage device 1306 or another computer-readable medium.

Storage device 1306 may include one or more data storage media, devices, or configurations and may employ any type, form, and combination of data storage media and/or device. For example, storage device 1306 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1306. For example, data representative of one or more executable applications 1312 configured to direct processor 1304 to perform any of the operations described herein may be stored within storage device 1306. In some examples, data may be arranged in one or more databases residing within storage device 1306.

I/O module 1308 may include one or more I/O modules configured to receive user input and provide user output. One or more I/O modules may be used to receive input for a single virtual experience. I/O module 1308 may include any hardware, firmware, software, or combination thereof supportive of input and output capabilities. For example, I/O module 1308 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1308 is configured to provide graphical data to a display for presentation to a user. The graphical data may be representative of one or more graphical user interfaces and/or any other graphical content as may serve a particular implementation.

The following clauses describe implementations of speculative messaging for memory transactions in a processor in accordance with principles described herein.
Clause 1. A method comprising: dispatching, from a core of a processor to a cache of the processor, a speculative message configured to direct the cache to begin performing a memory transaction, the speculative message being at least partially unvalidated; determining, by the core during a validation of the speculative message after the dispatching of the speculative message, a modification to the speculative message; and dispatching, from the core to the cache and in response to the determining of the modification, an override message indicating the modification.
Clause 2. The method of clause 1, wherein the speculative message is a first speculative message, the memory transaction is a first memory transaction, and the method further comprises: dispatching, from the core to the cache, a second speculative message configured to direct the cache to begin performing a second memory transaction, the second speculative message being at least partially unvalidated; determining, by the core during a validation of the second speculative message after the dispatching of the second speculative message, that the second speculative message is valid without modification; and in response to the determining that the second speculative message is valid without modification, abstaining from dispatching any override message associated with the second speculative message.
Clause 3. The method of clause 1 or 2, wherein: the speculative message includes a physical address for the memory transaction; the validation of the speculative message includes determining that the physical address is incorrect; and the modification indicated in the override message is configured to direct the cache to cancel the memory transaction.
Clause 4. The method of clause 1 or 2, wherein: the speculative message indicates that the memory transaction is a load transaction associated with a shared access type; the validation of the speculative message includes determining that the memory transaction is a store transaction associated with an exclusive access type; and the modification indicated in the override message directs the cache to replace the shared access type with the exclusive access type for the memory transaction.
Clause 5. The method of clause 1 or 2, wherein: the speculative message indicates that the memory transaction is a store transaction associated with an exclusive access type; the validation of the speculative message includes determining that the memory transaction is a load transaction associated with a shared access type; and the modification indicated in the override message directs the cache to replace the exclusive access type with the shared access type for the memory transaction.
Clause 6. The method of clause 1 or 2, wherein: the memory transaction is a first memory transaction; the method further comprises determining, during the validation of the speculative message, that the speculative message is valid without modification and that an additional memory transaction is requested for a same physical address as the first memory transaction; the first memory transaction is associated with a first access type; the additional memory transaction is associated with a second access type different from the first access type; and the modification indicated in the override message directs the cache to replace the first access type with the second access type for the first memory transaction.
Clause 7. The method of clause 1 or 2, wherein: the core of the processor is associated with a local cache separate from the cache to which the speculative message is dispatched; the speculative message lacks a request for the cache is to snoop the local cache, as part of the memory transaction, for a physical address related to the memory transaction; the validation of the speculative message includes determining that the local cache includes an entry for the physical address; and the modification indicated in the override message includes a request for the cache to snoop the local cache for the physical address.
Clause 8. The method of clause 1 or 2, wherein: the core of the processor is associated with a local cache separate from the cache to which the speculative message is dispatched; the speculative message includes a request for the cache to snoop, as part of the memory transaction, the local cache for a physical address related to the memory transaction; the validation of the speculative message includes determining that the local cache lacks an entry for the physical address; and the modification indicated in the override message directs the cache to ignore the request for the cache to snoop the local cache for the physical address.
Clause 9. The method of clause 1 or 2, wherein: the speculative message indicates that the memory transaction is associated with a cacheable memory type; the validation of the speculative message includes determining that the memory transaction is associated with a non-cacheable memory type; and the modification indicated in the override message directs the cache to replace the cacheable memory type with the non-cacheable memory type for the memory transaction.
Clause 10. The method of clause 1 or 2, wherein: the speculative message indicates that the memory transaction is associated with a cacheable memory type; the validation of the speculative message includes determining that the memory transaction is associated with a device memory type; and the modification indicated in the override message directs the cache to replace the cacheable memory type with the device memory type for the memory transaction.
Clause 11. The method of clause 1 or 2, wherein: the speculative message indicates that the memory transaction is associated with one of a non-cacheable memory type or a device memory type; the validation of the speculative message includes determining that the memory transaction is associated with a cacheable memory type; and the modification indicated in the override message directs the cache to replace the non-cacheable memory type or the device memory type with the cacheable memory type for the memory transaction.
Clause 12. The method of clause 1 or 2, wherein: the speculative message indicates that the memory transaction is associated with a first security indicator; the validation of the speculative message includes determining that the memory transaction is associated with a second security indicator that is different from the first security indicator; and the modification indicated in the override message directs the cache to replace the first security indicator with the second security indicator for the memory transaction.
Clause 13. The method of any of clauses 1 to 12, wherein the core and the cache are connected by a network, the network including a plurality of nodes and being configured to carry the speculative message and the override message from the core to the cache.
Clause 14. The method of any of clauses 1 to 13, wherein: the dispatching of the speculative message is performed during a first clock cycle; and the dispatching of the override message is performed during a second clock cycle that follows the first clock cycle by a predetermined fixed number of clock cycles.
Clause 15. A core of a processor, the core being configured to perform a process comprising: dispatching, to a cache of the processor, a speculative message configured to direct the cache to begin performing a memory transaction, the speculative message being at least partially unvalidated; determining, during a validation of the speculative message after the dispatching of the speculative message, a modification to the speculative message; and dispatching, to the cache and in response to the determining of the modification, an override message indicating the modification.
Clause 16. The core of clause 15, wherein the speculative message is a first speculative message, the memory transaction is a first memory transaction, and the process further comprises: dispatching, to the cache, a second speculative message configured to direct the cache to begin performing a second memory transaction, the second speculative message being at least partially unvalidated; determining, during a validation of the second speculative message after the dispatching of the second speculative message, that the second speculative message is valid without modification; and in response to the determining that the second speculative message is valid without modification, abstaining from dispatching any override message associated with the second speculative message.
Clause 17. The core of clause 15 or 16, wherein: the memory transaction is a first memory transaction; the process further comprises determining, during the validation of the speculative message, that the speculative message is valid without modification and that an additional memory transaction is requested for a same physical address as the first memory transaction; the first memory transaction is associated with a first access type; the additional memory transaction is associated with a second access type different from the first access type; and the modification indicated in the override message directs the cache to replace the first access type with the second access type for the first memory transaction.
Clause 18. A processor comprising: a cache configured to perform memory transactions; and a core configured to direct the memory transactions by performing a process comprising: dispatching, to the cache, a speculative message configured to direct the cache to begin performing a memory transaction, the speculative message being at least partially unvalidated; determining, during a validation of the speculative message after the dispatching of the speculative message, a modification to the speculative message; and dispatching, to the cache and in response to the determining of the modification, an override message indicating the modification.
Clause 19. The processor of clause 18, wherein the speculative message is a first speculative message, the memory transaction is a first memory transaction, and the process further comprises: dispatching, to the cache, a second speculative message configured to direct the cache to begin performing a second memory transaction, the second speculative message being at least partially unvalidated; determining, during a validation of the second speculative message after the dispatching of the second speculative message, that the second speculative message is valid without modification; and in response to the determining that the second speculative message is valid without modification, abstaining from dispatching any override message associated with the second speculative message.
Clause 20. The processor of clause 18 or 19, wherein: the memory transaction is a first memory transaction; the process further comprises determining, during the validation of the speculative message, that the speculative message is valid without modification and that an additional memory transaction is requested for a same physical address as the first memory transaction; the first memory transaction is associated with a first access type; the additional memory transaction is associated with a second access type different from the first access type; and the modification indicated in the override message directs the cache to replace the first access type with the second access type for the first memory transaction.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
dispatching, from a core of a processor to a cache of the processor, a speculative message configured to direct the cache to begin performing a memory transaction, the speculative message being at least partially unvalidated;
determining, by the core during a validation of the speculative message after the dispatching of the speculative message, a modification to the speculative message; and
dispatching, from the core to the cache and in response to the determining of the modification, an override message indicating the modification.

2. The method of claim 1, wherein the speculative message is a first speculative message, the memory transaction is a first memory transaction, and the method further comprises:
dispatching, from the core to the cache, a second speculative message configured to direct the cache to begin performing a second memory transaction, the second speculative message being at least partially unvalidated;
determining, by the core during a validation of the second speculative message after the dispatching of the second speculative message, that the second speculative message is valid without modification; and
in response to the determining that the second speculative message is valid without modification, abstaining from dispatching any override message associated with the second speculative message.

3. The method of claim 1, wherein:
the speculative message includes a physical address for the memory transaction;
the validation of the speculative message includes determining that the physical address is incorrect; and
the modification indicated in the override message is configured to direct the cache to cancel the memory transaction.

4. The method of claim 1, wherein:
the speculative message indicates that the memory transaction is a load transaction associated with a shared access type;
the validation of the speculative message includes determining that the memory transaction is a store transaction associated with an exclusive access type; and
the modification indicated in the override message directs the cache to replace the shared access type with the exclusive access type for the memory transaction.

5. The method of claim 1, wherein:
the speculative message indicates that the memory transaction is a store transaction associated with an exclusive access type;
the validation of the speculative message includes determining that the memory transaction is a load transaction associated with a shared access type; and
the modification indicated in the override message directs the cache to replace the exclusive access type with the shared access type for the memory transaction.

6. The method of claim 1, wherein:
the memory transaction is a first memory transaction;
the method further comprises determining, during the validation of the speculative message, that the speculative message is valid without modification and that an additional memory transaction is requested for a same physical address as the first memory transaction;
the first memory transaction is associated with a first access type;
the additional memory transaction is associated with a second access type different from the first access type; and
the modification indicated in the override message directs the cache to replace the first access type with the second access type for the first memory transaction.

7. The method of claim 1, wherein:
the core of the processor is associated with a local cache separate from the cache to which the speculative message is dispatched;
the speculative message lacks a request for the cache is to snoop the local cache, as part of the memory transaction, for a physical address related to the memory transaction;
the validation of the speculative message includes determining that the local cache includes an entry for the physical address; and
the modification indicated in the override message includes a request for the cache to snoop the local cache for the physical address.

8. The method of claim 1, wherein:
the core of the processor is associated with a local cache separate from the cache to which the speculative message is dispatched;
the speculative message includes a request for the cache to snoop, as part of the memory transaction, the local cache for a physical address related to the memory transaction;
the validation of the speculative message includes determining that the local cache lacks an entry for the physical address; and
the modification indicated in the override message directs the cache to ignore the request for the cache to snoop the local cache for the physical address.

9. The method of claim 1, wherein:
the speculative message indicates that the memory transaction is associated with a cacheable memory type;
the validation of the speculative message includes determining that the memory transaction is associated with a non-cacheable memory type; and
the modification indicated in the override message directs the cache to replace the cacheable memory type with the non-cacheable memory type for the memory transaction.

10. The method of claim 1, wherein:
the speculative message indicates that the memory transaction is associated with a cacheable memory type;
the validation of the speculative message includes determining that the memory transaction is associated with a device memory type; and
the modification indicated in the override message directs the cache to replace the cacheable memory type with the device memory type for the memory transaction.

11. The method of claim 1, wherein:
the speculative message indicates that the memory transaction is associated with one of a non-cacheable memory type or a device memory type;
the validation of the speculative message includes determining that the memory transaction is associated with a cacheable memory type; and
the modification indicated in the override message directs the cache to replace the non-cacheable memory type or the device memory type with the cacheable memory type for the memory transaction.

12. The method of claim 1, wherein:
the speculative message indicates that the memory transaction is associated with a first security indicator;
the validation of the speculative message includes determining that the memory transaction is associated with a second security indicator that is different from the first security indicator; and
the modification indicated in the override message directs the cache to replace the first security indicator with the second security indicator for the memory transaction.

13. The method of claim 1, wherein the core and the cache are connected by a network, the network including a plurality of nodes and being configured to carry the speculative message and the override message from the core to the cache.

14. The method of claim 1, wherein:
the dispatching of the speculative message is performed during a first clock cycle; and
the dispatching of the override message is performed during a second clock cycle that follows the first clock cycle by a predetermined fixed number of clock cycles.

15. A core of a processor, the core being configured to perform a process comprising:
dispatching, to a cache of the processor, a speculative message configured to direct the cache to begin performing a memory transaction, the speculative message being at least partially unvalidated;
determining, during a validation of the speculative message after the dispatching of the speculative message, a modification to the speculative message; and
dispatching, to the cache and in response to the determining of the modification, an override message indicating the modification.

16. The core of claim 15, wherein the speculative message is a first speculative message, the memory transaction is a first memory transaction, and the process further comprises:
dispatching, to the cache, a second speculative message configured to direct the cache to begin performing a second memory transaction, the second speculative message being at least partially unvalidated;
determining, during a validation of the second speculative message after the dispatching of the second speculative message, that the second speculative message is valid without modification; and
in response to the determining that the second speculative message is valid without modification, abstaining from dispatching any override message associated with the second speculative message.

17. The core of claim 15, wherein:
the memory transaction is a first memory transaction;
the process further comprises determining, during the validation of the speculative message, that the speculative message is valid without modification and that an additional memory transaction is requested for a same physical address as the first memory transaction;
the first memory transaction is associated with a first access type;
the additional memory transaction is associated with a second access type different from the first access type; and
the modification indicated in the override message directs the cache to replace the first access type with the second access type for the first memory transaction.

18. A processor comprising:
a cache configured to perform memory transactions; and
a core configured to direct the memory transactions by performing a process comprising:
dispatching, to the cache, a speculative message configured to direct the cache to begin performing a memory transaction, the speculative message being at least partially unvalidated;
determining, during a validation of the speculative message after the dispatching of the speculative message, a modification to the speculative message; and
dispatching, to the cache and in response to the determining of the modification, an override message indicating the modification.

19. The processor of claim 18, wherein the speculative message is a first speculative message, the memory transaction is a first memory transaction, and the process further comprises:
dispatching, to the cache, a second speculative message configured to direct the cache to begin performing a second memory transaction, the second speculative message being at least partially unvalidated;
determining, during a validation of the second speculative message after the dispatching of the second speculative message, that the second speculative message is valid without modification; and
in response to the determining that the second speculative message is valid without modification, abstaining from dispatching any override message associated with the second speculative message.

20. The processor of claim 18, wherein:
the memory transaction is a first memory transaction;
the process further comprises determining, during the validation of the speculative message, that the speculative message is valid without modification and that an additional memory transaction is requested for a same physical address as the first memory transaction;
the first memory transaction is associated with a first access type;
the additional memory transaction is associated with a second access type different from the first access type; and
the modification indicated in the override message directs the cache to replace the first access type with the second access type for the first memory transaction.
